(19) United States
(12) Patent Application Publication
(10) Pub. No.: US 2012/0009996 A1
(43) Pub. Date: Jan. 12, 2012

(54) GAMING DEVICE, GAME CONTROL METHOD, INFORMATION RECORDING MEDIUM, AND PROGRAM

(76) Inventor: Takehiro Masashi, Tokyo (JP)

(21) Appl. No.: 13/257,530

(22) PCT Filed: Mar. 18, 2010
(86) PCT No.: PCT/JP2010/054693

§ 371 Date: Sep. 19, 2011

(30) Foreign Application Priority Data
Mar. 25, 2009 (JP) 2009-073888

(51) Int. Cl. A63F 13/00; A63F 13/06

(52) U.S. Cl. 463/35; 463/36

(57) ABSTRACT

A gaming device (700) comprises an output unit (701), a reception unit (702), and a determination unit (703). The output unit (701) starts to output sound of a given tone at a given task time. The reception unit (702) receives operation input from the player. The determination unit (703) determines whether the time when operation input is received is included a given task time span including the task time. The output unit (701) changes the volume of the sound having started to be output at the task time in accordance with the determination result by the determination unit (703).

### TECHNICAL FIELD

The present invention relates to a gaming device, game control method, information recording medium, and program capable of outputting sound corresponding to operation input properly at indicated times in a game in which the player implements operation input at the indicated times.

### BACKGROUND ART

Music games in which players operate buttons or foot switches in rhythm to music or to screen display have long been known. In such a music game, for example, given objects appear from the bottom of a screen and move up in time with played music. When the objects reach a judgment line serving as the baseline for judgment, the player presses a button. As the player presses a button, sound indicating the button being pressed is output.

When the button is pressed in a timely manner, a score is added. In other words, when it is determined that the time of implementation of operation input is included in a given time span (“a task time span” hereafter), the button is considered to be pressed in a timely manner. Here, the length of a task time span determines the length of time within which operation input is considered to be implemented in a timely manner. In other words, the length of a task time span determines the acceptable level of operation input. As the length of a task time span is decreased, the game will be of a higher difficulty level. On the other hand, as the length of a task time span is increased, the game will be of a lower difficulty level. Therefore, in such a gaming device, the length of a task time span can be adjusted according to the player's skill to alter the difficulty level of the game.

For example, if the player is a skilled player, the task time span is set to a small length. In such a case, the time span within which operation input is considered to be implemented in a timely manner is small. Therefore, the timing of operation input is judged more strictly. On the other hand, if the player is a beginner, the task time span can be set to a larger length. In such a case, the timing of operation input is judged more roughly. Such a gaming device is disclosed, for example, in Patent Literature 1. Patent Literature 1: Unexamined Japanese Patent Application KOKAI Publication No. 2008-125721

In a gaming device as described above, when the player presses a button, sound indicating the button being pressed is output. When the sound is output have no relation to the difficulty level of a game. Therefore, if there is a significant time difference between the time when a button is pressed and the time when a given object reaches the line, the sound is output out of sync with the rhythm of music. Then, the player may fail to keep up with the rhythm. For this reason, there is a demand for the sound being output in a natural manner in accordance with operation input by the player. Furthermore, there is also a demand for the operation input determination result being presented to the player by sound.

The present invention is invented in view of the above problem and an exemplary object of the present invention is to provide a gaming device, game control method, information recording medium, and program capable of outputting sound corresponding to operation input properly at indicated times in a game in which the player implements operation input at the indicated times.

### DISCLOSURE OF INVENTION

In order to achieve the above object, the gaming device according to a first exemplary aspect of the present invention comprises an output unit, a reception unit, and a determination unit, and is configured as follows.

The output unit starts to output sound of a given tone at a given task time. Here, the task time is the benchmark time for the player of the gaming device to implement operation input. Typically, the player implements operation input so that the task time and the time of implementation of operation input are equal. Here, the output sound may correspond to, for example, the type of expected operation input (the type of a button to be pressed). The output unit starts to output sound at the task time regardless of the time or presence/absence of operation input.

Then, the reception unit receives operation input from the player. The operation input can be, for example, the player's operation of various buttons or a lever of the controller of the gaming device. The buttons are typically those operated by hands or feet such as foot switches. Alternatively, the operation input can be the player's operation of a controller member imitating various musical instruments. It is possible to assume implementation of operation input when a given motion of the player is detected by various sensors.

Here, the determination unit determines whether the time when the operation input is received (“the operation time” hereafter) is included in a given task time span including the task time. The task time span is a time span within which the player should implement operation input. Therefore, if the operation time is included in the task time span, the operation input is determined to be successful. On the other hand, if the operation time is not included in the task time span, the operation input is determined to be unsuccessful. For determining whether operation input is successful or unsuccessful, the type of operation input can further be taken into consideration. Here, the length of the task time span determines the acceptable level of operation input as being successful. Therefore, if the task time span is small, the game is of a high difficulty level. On the other hand, if the task time span is large, the game is of a low difficulty level. Information indicating the task time span can be incorporated in a program executed by the gaming device. Furthermore, such information can be stored in the storage device of the gaming device.

The output unit changes the volume of the sound having started to be output at the task time in accordance with the determination result by the determination unit. For example, when the operation input is determined to be successful, the sound volume is increased. On the other hand, when the operation input is determined to be unsuccessful, the sound volume is unchanged. Generally, the sound is determined by elements such as sound loudness (amplitude), pitch (basic frequency), and tone (frequency profile). Among them, the output unit changes the sound volume by changing the loudness of sound.

The gaming device of the present invention can output sound corresponding to operation input in a timely manner. Furthermore, it can change the sound volume output since the task time in accordance with the determination result of operation input by the player. Consequently, for example, the player can know whether the operation input was successful by the sound volume. In such a case, the sound starts to be output at a given time to implement operation input. Therefore, the sound output does not depend on the time when operation input is actually implemented by the player. In this way, the sound is output in time with the rhythm of music regardless of how good or bad operation input is implemented.

Furthermore, in the gaming device of the present invention, the task time span can be a time span from the time precedent to the task time by a given preceding time to the time after elapse of a time period during which the sound is output since the task time. In such a case, the sound output ends at the end time of the task time span. Then, the determination result of operation input implemented by the end time of the task time span is reflected in the sound volume. Here, the start time of the task time span is determined, for example, according to the difficulty level of the game. In other words, if the game is of a high difficulty level, the preceding time is reduced. If the game is of a low difficulty level, the preceding time is extended. Then, the start time of the task time span is set to the time precedent to the task time by the preceding time.

The gaming device of the present invention can properly let the player know whether the operation input was successful by the sound volume.

Furthermore, in the gaming device of the present invention, it is possible that the determination unit further determines whether the operation time is after the task time span, and the output unit changes the volume of the sound being output since the task time to zero if the determination unit determines that the operation time is after the task time span.

More specifically, first, the determination unit determines whether operation input is implemented after elapse of the task time span. Typically, when operation input is implemented after elapse of the task time span, the operation input is unsuccessful. Therefore, in such a case, the output unit changes the volume of the sound being output since the task time to zero to let the player know that the operation input was unsuccessful.

The gaming device of the present invention can properly let the player know whether the operation input was successful by the sound volume.

Furthermore, in the gaming device of the present invention, operation input received by the reception unit can be operation input associated with the given task time or other operation input. Here, the operation input associated with a given task time is, for example, input of operation of pressing a button to be pressed at a given task time. Then, the other operation input is input of operation of pressing a button other than the button of interest. Here, the determination unit determines whether the time when the other operation input is received is included in the task time span. Then, the output unit changes the volume of the sound output since the task time to zero when the determination unit determines that the time if the other operation input is received is included in the task time span. In this way, the sound volume is changed to zero when operation input implemented within the task time span is different from expected operation input. Consequently, the player is informed that the implemented operation input was not the expected operation input.

The gaming device of the present invention can properly let the player know whether the operation input was successful by the sound volume.

Furthermore, the gaming device of the present invention may further comprise a detection unit and be configured as follows. In other words, the detection unit detects the time difference between the operation time and task time. The detected time difference is a quantitative indicator of the achievement level of operation input implemented by the player. In other words, as the detected time difference is smaller, the operation was implemented more timely.

Here, the output unit changes the volume of the sound being output since the task time in accordance with the detected time difference when the determination unit determines that the operation time is included in the task time span. In other words, the output unit changes the sound volume in accordance with how timely the operation input was when the operation time is included in the task time span. In other words, the output unit does not change the sound volume uniformly.

The gaming device of the present invention can properly let the player know how timely the operation input was implemented by the sound volume.

Furthermore, in the gaming device of the present invention, the output unit may increase the volume of the sound being output since the task time as the detected time difference is smaller. As mentioned above, the operation input is considered to be implemented more timely as the detected time difference is smaller. Therefore, the sound volume is increased as the operation input is implemented more timely. Then, the player can know how timely the operation input was implemented from the sound volume.

The gaming device of the present invention can properly let the player know how timely the operation input was implemented by the sound volume.

Furthermore, the gaming device of the present invention may further comprise a score unit accumulating scores corresponding to the detected time difference. For example, a higher score is added as the detected time difference is smaller. Consequently, the score can indicate how timely the operation input was as a whole up to the current time from the start of the game. Here, the score may depend on the determination result by the determination unit. Alternatively, the score may not depend on the determination result. Therefore, no score may be added even if the operation input is determined to be successful. No score may be added when the operation input is determined to be unsuccessful, either.

The gaming device of the present invention can properly let the player know how timely each operation input was implemented by the sound volume while the score indicates the evaluation of operation input up to the current time from the start of the game.

In order to achieve the above object, the game control method according to another exemplary aspect of the present invention is a game control method executed by a gaming device comprising an output unit, a reception unit, and a determination unit, and configured as follows.

In an output step, the output unit performs outputting sound of a given tone at a given task time.

In a reception step, the reception unit performs receiving operation input from a player.

In a determination step, the determination unit performs determining whether the time when the operation input is received (“the operation time” hereafter) is included in a given task time span including the task time.

Here, in the output step, the output unit performs changing the volume of the sound having started to be output at the task time in accordance with the determination result by the determination unit.

The program according to another exemplary aspect of the present invention allows a computer to function as an output unit, a reception unit, and a determination unit.

The output unit starts to output sound of a given tone at a given task time.

The reception unit receives operation input from the player.

The determination unit determines whether the time when the operation input is received (“the operation time” hereafter) is included in a given task time span including the task time.

Here, the output unit changes the volume of the sound having started to be output at the task time in accordance with the determination result by the determination unit.

The present invention allows a computer to function as the gaming device operating as described above.

The information recording medium according to another exemplary aspect of the present invention records a program that allows a computer to function as an output unit, a reception unit, and a determination unit.

The output unit starts to output sound of a given tone at a given task time.

The reception unit receives operation input from the player.

The determination unit determines whether the time when the operation input is received (“the operation time” hereafter) is included in a given task time span including the task time.

Here, the output unit changes the volume of the sound having started to be output at the task time in accordance with the determination result by the determination unit.

The present invention allows a computer to function as the gaming device operating as described above.

The program of the present invention can be recorded on a computer-readable information recording medium such as a compact disc, flexible disc, hard disc, magneto-optical disc, digital video disc, magnetic tape, and semiconductor memory. The above program can be distributed/sold independently from a computer on which the program is executed via a computer communication network. Furthermore, the above information recording medium can be distributed/sold independently from the computer.

### EFFECT OF THE INVENTION

The present invention can provide a gaming device, game control method, information recording medium, and program capable of outputting sound corresponding to operation input properly at indicated times in a game in which the player implements operation input at the indicated times.

### BRIEF DESCRIPTION OF DRAWINGS

FIG. 1A diagram showing the general configuration of a typical information processing device in which the gaming device according to an embodiment of the present invention is realized;

FIG. 2 A schematic illustration showing the general structure of a mat type controller connectable to the gaming device;

FIG. 3 An illustration for explaining the display screen of the gaming device;

FIG. 4 An illustration showing data stored in the RAM;

FIG. 5A An illustration for explaining the movement of targets on the game screen;

FIG. 5B An illustration for explaining a time to implement operation input;

FIG. 6A A graphical representation for explaining sound to be reproduced in a time span during which operation input should be implemented;

FIG. 6B A graphical representation for explaining how the sound volume is changed when operation input is successfully implemented;

FIG. 7 A block diagram showing the configuration of the gaming device according to an embodiment of the present invention;

FIG. 8 A flowchart of the game control process executed by the gaming device according to an embodiment of the present invention;

FIG. 9 A flowchart of the initialization procedure shown in the flowchart of FIG. 8;

FIG. 10 A flowchart of the score addition procedure shown in the flowchart of FIG. 8;

FIG. 11 A flowchart of the determination procedure shown in the flowchart of FIG. 8;

FIG. 12A A graphical representation for explaining how the sound volume is changed when the correct button is pressed in the time span from the start time to the task time and operation input is successful (in the case of a small time difference) in an embodiment of the present invention;

FIG. 12B A graphical representation for explaining how the sound volume is changed when the correct button is pressed in the time span from the start time to the task time and operation input is successful (in the case of a large time difference) in an embodiment of the present invention;

FIG. 13A A graphical representation for explaining how the sound volume is changed when the correct button is pressed in the time span from the task time to the end time and operation input is successful (in the case of a small time difference) in an embodiment of the present invention;

FIG. 13B A graphical representation for explaining how the sound volume is changed when the correct button is pressed in the time span from the task time to the end time and operation input is successful (in the case of a large time difference) in an embodiment of the present invention;

FIG. 14 A graphical representation for explaining how the sound volume is changed when the correct button is not pressed within the task time span and operation input is unsuccessful in an embodiment of the present invention;

FIG. 15 A flowchart of the determination procedure executed by the gaming device according to Modified Embodiment 1;

FIG. 16 A graphical representation for explaining how the sound volume is changed when a wrong button is pressed in the time span from the start time to the task time and operation input is unsuccessful in Modified Embodiment 1;

FIG. 17 A graphical representation for explaining how the sound volume is changed when a wrong button is pressed in the time span from the task time to the end time and operation input is unsuccessful in Modified Embodiment 1;

FIG. 18 A graphical representation for explaining how the sound volume is changed when the correct button is not pressed in the task time span and operation input is unsuccessful in Modified Embodiment 2; and

FIG. 19 A graphical representation for explaining how the sound volume is changed when any button is pressed after the end time and operation input is unsuccessful in Modified Embodiment 3.

### BEST MODE FOR CARRYING OUT THE INVENTION

Embodiments of the present invention will be described hereafter. In the following embodiments, for easier understanding, the present invention is applied to an information processing device specialized for games. However, the present invention is similarly applicable to various information processing devices such as computers, PDAs (personal data assistants), and cell-phones. In other words, the following embodiments are given for the purpose of explanation and the scope of the invention of the present application is not confined thereto. A person of ordinary skill in the field may embrace an embodiment in which some or all of the components are replaced with equivalent counterunits. Such an embodiment falls under the scope of the present invention.

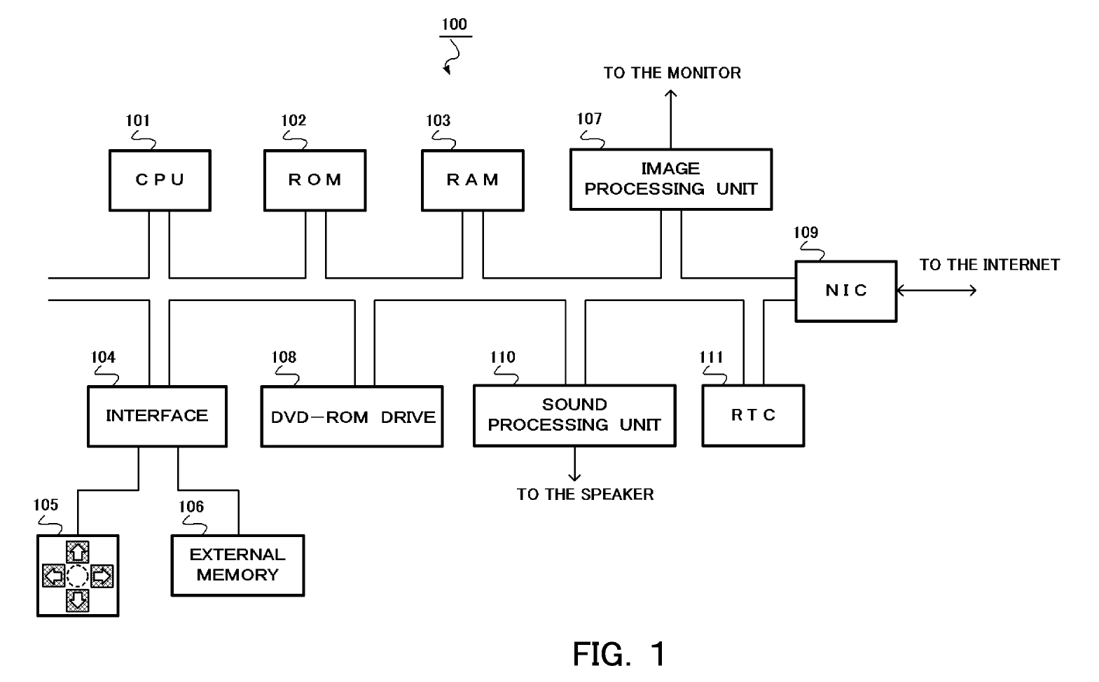

FIG. 1 is a diagram showing the general configuration of a typical information processing device in which the gaming device according to an embodiment of the present invention is realized. The following explanation is made with reference to this figure.

An information processing device 100 comprises a CPU (Central Processing Unit) 101, a ROM (Read Only Memory) 102, a RAM (Random Access Memory) 103, an interface 104, a mat type controller 105, an external memory 106, an image processing unit 107, a DVD (Digital Versatile Disk)-ROM drive 108, a NIC (Network Interface Card) 109, a sound processing unit 110, and a RTC (Real Time Clock) 111.

First, the player mounts a DVD-ROM on which game programs and data are stored onto the DVD-ROM drive 108. Then, the player powers on the information processing device 100. Upon power-on, the programs are executed so that the gaming device of this embodiment is realized.

The CPU 101 controls the operation of the entire information processing device 100. The CPU 101 is connected to the components. Furthermore, the CPU 101 exchanges control signals and data with the components. The CPU 101 acquires various data from the components, performs various operations on the various data, and supplies them to the components as data or control signals. The CPU 101 comprises a cache and registers. The CPU 101 temporarily stores the various data in the cache. Then, a register acquires the various data. Then, the CPU 101 performs various operations on the various data.

The ROM 102 records an IPL (initial program loader) that is executed immediately after power-on. With the IPL executed, programs recorded on the DVD-ROM are read onto the RAM 103. Then, the CPU 101 starts to execute the programs.

The ROM 102 further records the programs and various data of an operation system. The operation system is essential for controlling the operation of the entire information processing device 100.

The RAM 103 temporarily stores data and programs. The RAM 103 temporarily retains programs and data read from the DVD-ROM, or other data necessary for carrying on a game or for communication. In addition, various pieces of information transmitted from various devices connected to the information processing device 100 and various pieces of information to transmit to the various devices are also temporarily stored.

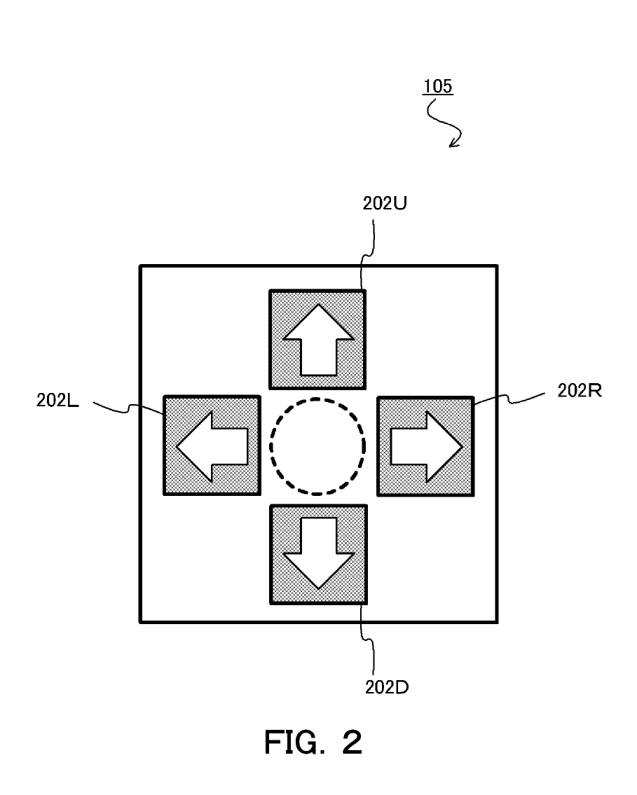

The mat type controller 105 connected via the interface 104 receives operation input from the player during implementation of a game. FIG. 2 is an illustration showing the appearance of the mat type controller 105. The mat type controller 105 will be described hereafter with reference to this figure.

FIG. 2 is a schematic illustration of the mat type controller 105 placed on a floor and viewed from directly above. The mat type controller 105 has buttons 202L, 202D, 202U, and 202R in given regions. The button 202L receives input indicating “left” from the player. The button 202D receives input indicating “down” from the player. The button 202U receives input indicating “up” from the player. The button 202R receives input indicating “right” from the player. The player can press the button 202L, 202D, 202U, or 202R (which will collectively be termed the buttons 202 hereafter where necessary) at any time. The CPU 101 determines whether each of the buttons 202 is pressed.

In this embodiment, the mat type controller 105 comprises four buttons 202. However, the number of buttons is not restricted to four and can be three or less or five or more. Furthermore, the mat type controller 105 is not necessarily placed on a floor. The mat type controller 105 can be so-called of a touch pad type or a hand-held type, which is operated by hand.

Returning to FIG. 1, the external memory 106 is connected via the interface 104 in a removable manner. The external memory 106 stores data presenting the progress of a game. The external memory 106 is rewritable. For example, as the player implements command input through the mat type controller 105, the data may be recorded on the external memory 106 when appropriate.

A DVD-ROM is mounted on the DVD-ROM drive 108. Programs for realizing a game and image and sound data accompanying the game are recorded on the DVD-ROM. The DVD-ROM drive 108 reads the mounted DVD-ROM under the control of the CPU 101. Then, necessary programs and data are read. They are temporarily stored in the RAM 103.

The image processing unit 107 comprises an image calculation processor (not shown) and a frame memory (not shown). The image processing unit 107 processes data read from the DVD-ROM by means of the CPU 101 and image calculation processor. Then, the image processing unit 107 records the processed data in the frame memory. The image information recorded in the frame memory is converted to video signals at given synchronized times. Then, the image information is output to a monitor (not shown) connected to the image processing unit 107. Consequently, various images can be displayed.

The image calculation processor is capable of two-dimensional image superposition calculation, transmission calculation such as a-blending, and various saturate calculation at high speeds. A polygon is placed in a virtual three-dimensional space. The polygon information includes various kinds of additional texture information. High-speed calculation of rendering images can be done by rendering the polygon information by the Z buffer method. A rendering image can be obtained by looking down at a polygon from a given viewing point. Particularly, a library or hardware for calculating the degree to which a polygon is illuminated by a typical (positive) light source has been devised. The typical light source can be a point light, collimated light source, or conical light source. The library or hardware makes the calculation faster.

Furthermore, a string of characters can be rendered on a frame memory or polygon surface as a two-dimensional image by cooperation of the CPU 101 and image calculation processor. The string of characters is rendered according to font information defining the shapes of characters. The font information is recorded on the ROM 102. However, special font information recorded on the DVD-ROM can be used.

The NIC 109 is used for connecting the information processing device 100 to a computer communication network (not shown) such as the Internet. The NIC 109 is an interface mediating between various Internet connection devices and the CPU 101. Various Internet connection devices include those in conformity to 10BASE-T/100BASE-T standards for configuring a LAN (Local Area Network), analog modems for connecting to the Internet via a telephone line, ISDN (Integrated Service Digital Network) modems, ADSL (Asymmetric Digital Subscriber Lline) modems, and cable modems for connecting to the Internet via a cable television line.

The sound processing unit 110 converts sound data read from the DVD-ROM to analog signals. Then, the sound processing unit 110 outputs sound from a speaker (not shown) connected thereto. Furthermore, the sound processing unit 110 creates sound effects and music data to generate in the course of a game under the control of the CPU 101. Then, the sound processing unit 110 outputs sound corresponding to the created sound effects and music data from the speaker. The sound processing unit 110 outputs, for example, the sound of music reproduced as BGM or Karaoke, or sound effects reproduced in time with button operation of the player.

The RTC 111 is a timing device comprising a quartz oscillator or oscillation circuit. The RTC 111 is powered by a built-in battery and continues to operate even if the information processing device 100 is powered off.

Additionally, the information processing device 100 can be configured with a large capacity external storage device such as a hard disc that fulfils the same function as the ROM 102, RAM 103, external memory 106, and DVD-ROM mounted on the DVD-ROM drive 108.

(Explanation of Display Screen)

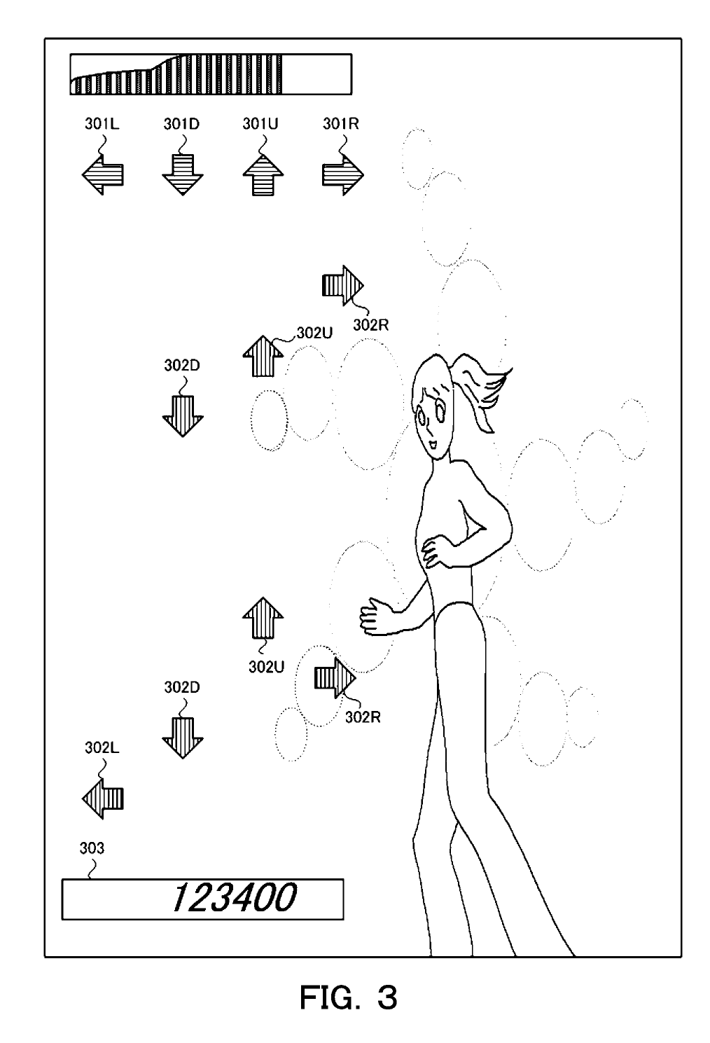

The display screen of the gaming device according to this embodiment will be described hereafter with reference to FIG. 3. The gaming device according to this embodiment will be described as a gaming device executing a dance game.

The gaming device displays various pieces of information necessary for a dance game. For example, the gaming device displays a list of pieces of music before the game starts to urge the player to select a desired piece of music. Then, after a piece of music is selected and the game starts, the gaming device displays a game screen as shown in FIG. 3 by way of example.

On this game screen, still marks 301L, 301D, 301U, and 301R (which will collectively be termed the still marks 301 hereafter where necessary) are fixed images showing the player times to step. On the other hand, targets 302L, 302D, 302U, and 302R (which will collectively be termed the targets 302 hereafter where necessary) are images showing the player task steps. The targets 302, for example, scroll up from the bottom of the screen in time with the played music. If the player implements the required task step when the targets 302 reach the still marks 301 (when the images of the targets 302 and still marks 301 overlap with each other), a score is added in accordance with how timely the stepping was. The score accumulated from the start of the game to the current time (“the total score” hereafter) is displayed in a score display region 303. Here, when the targets 302 reach the still marks 301, sound corresponding to the button 202 to be stepped on is reproduced. Furthermore, if the player implements the required step in a timely manner, the sound volume is increased. In this way, with the sound volume being changed depending on whether the stepping was successful, the player can know whether the stepping was successful.

In this embodiment, task data, a music data column, and a sound data column are prepared as data for realizing the above game control process. These data are recorded in advance on, for example, a DVD-ROM to be mounted on the DVD-ROM drive 108 and read onto the RAM 103 as necessary.

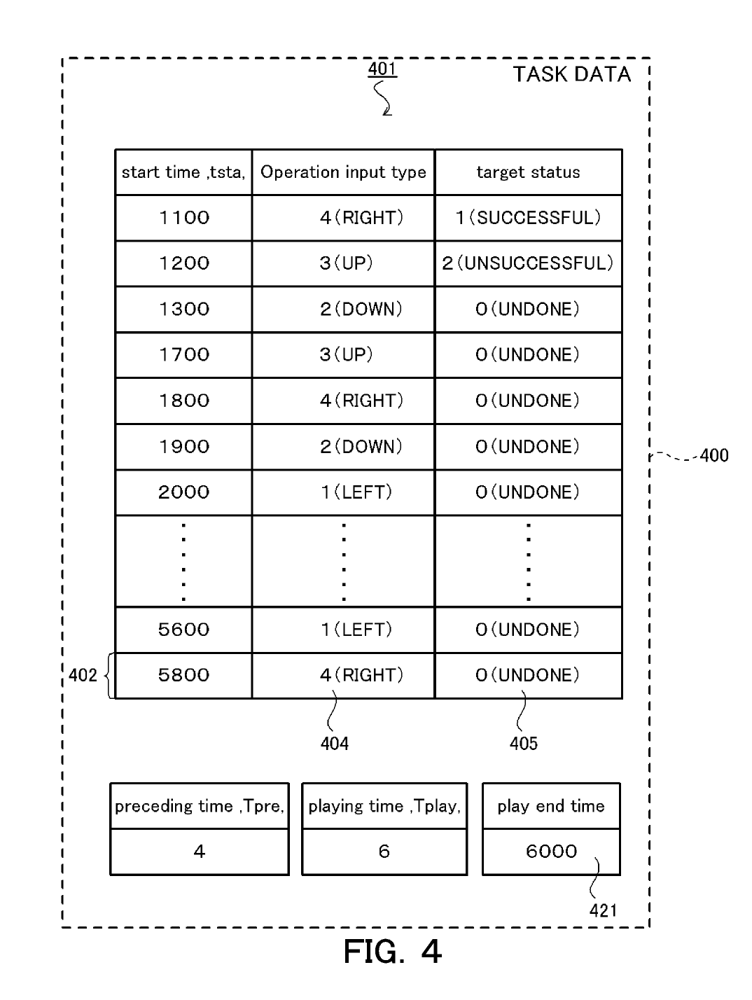

The task data will be described in detail hereafter with reference to FIG. 4. FIG. 4 is a schematic illustration showing task data read onto the task data region of the RAM 103.

Task data 400 correspond to a musical score for music. In this embodiment, the task data 400 are data including a table 401 consisting of multiple records 402, a preceding time, Tpre, a playing time, Tplay, and a play end time 421 (which is assumed to have a value E). Each record 402 has fields recording a start time, tsta, an operation input type 404, and a target status 405. Each record 402 corresponds to a musical note.

The start time, tsta, is the time when a target 302 reaches a still mark 301. The start time, tsta, is also the earliest time in a time span during which the player should implement the operation input (step on the button 202) in regard to the target 302.

The operation input type is data indicating a button the player should step on among the buttons 202L, 202D, 202U, and 202R after the start time, tsta.

The preceding time, Tpre, is the time period from the start time, tsta, to the time when sound starts to be reproduced.

The playing time, Tplay, is the time period during which the sound is reproduced.

The play end time 421 is the time when playing of BGM corresponding to the music ends.

Here, any method of determining whether operation input in regard to a target 302 associated with a record 402 is successful can appropriately be selected. In this embodiment, operation input is determined to be successful when a button corresponding to the operation input type 404 is operated: (a) at the start time, tsta; or (b) after the start time, tsta, and before the preceding time, Tpre, has elapsed or before the playing time, Tplay, has further elapsed.

Otherwise, the operation input is determined to be unsuccessful. Hence, the operation input is considered to be successful when the total time of the preceding time, Tpre, and playing time, Tplay, is shorter than the elapsed time from the start time, tsta, to the time when the player stepped on the button 202.

The music data column is a data column expressing music reproduced as BGM.

The sound data column is a data column expressing task time indication sound.

The start time, tsta, operation input type 404, preceding time, Tpre, playing time, Tplay, and play end time 421 are information read from the DVD-ROM. The target status 405 is initialized to “0” indicating “undone” immediately after the game starts. Information such as “1” indicating “successful” and “2” indicating “unsuccessful” is stored in the target status 405 in a procedure described later.

The start time, tsta, records a numeric value in units of a vertical synchronizing interrupt cycle (typically, 1/60 second) that is the screen display update rate. The records 402 are sorted in the ascending order by the start time, tsta. Numerical values recorded as the preceding time, Tpre, playing time, Tplay, and play end time 421 are also presented in units of the above cycle. These time and time periods will be presented by a numeric value in units of the above cycle (“the number of times of screen update” hereafter). On the other hand, the operation input type 404 presents a button to be operated among the four buttons 202 of the mat type controller 105 by numbers “1” to “4.” For example, the button 202L is indicated by the number “1”; the button 202D, “2”; the button 202U, “3”; and the button 202R, “4.” Here, the button 202L receives input indicating “left” from the player. The button 202D receives input indicating “down” from the player. The button 202U receives input indicating “up” from the player. The button 202R receives input indicating “right” from the player.

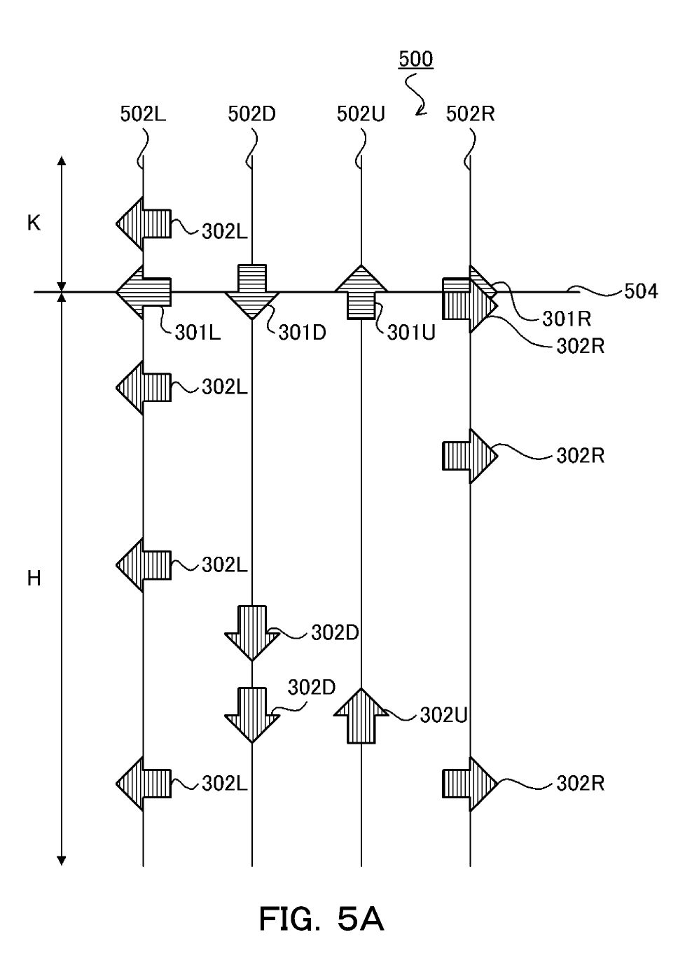

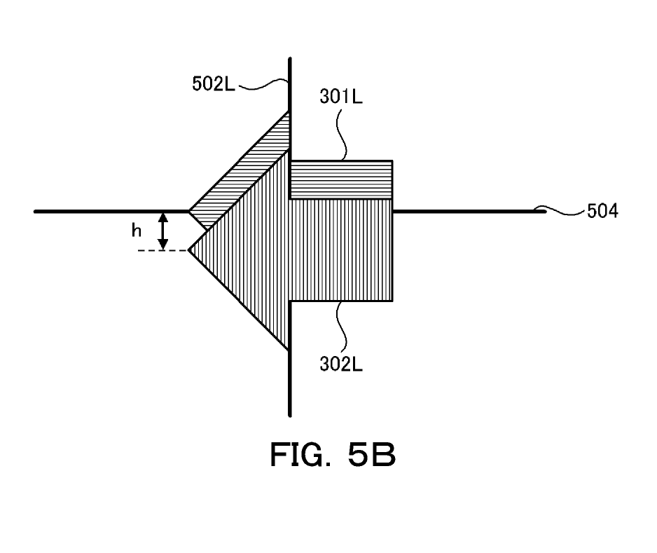

A screen displayed on the monitor using image signals output from the gaming device according to this embodiment will be described hereafter with reference to FIGS. 5A and 5B. FIG. 5A is an illustration for explaining the movement of targets 302 on the game screen shown in FIG. 3. FIG. 5B is an illustration for explaining the time to implement operation input.

As shown in FIG. 5A, in this embodiment, four moving paths are prepared for the targets 302 in accordance with the buttons 202 of the mat type controller 105. On a screen 500, four vertical moving paths 502L, 502D, 502U, and 502R (which will collectively be termed the moving paths 502 hereafter where necessary) are provided. Because there are four operation input types 404, four moving paths 502 are provided. Each moving path 502 is associated with one of the four operation input types. More specifically, the moving path 502L is associated with “left”; the moving path 502D, “down”; the moving path 502U, “up”; and the moving path 502R, “right.” The targets 302 are displayed on the moving paths 502.

The targets 302 are presented by arrow images. The arrows point up, down, left or right. The arrows of the targets 302 point in accordance with the moving paths 502. More specifically, the target 302L displayed on the moving path 502L is presented by an image of an arrow pointing left. The target 302D displayed on the moving path 502D is presented by an image of an arrow pointing down. The target 302U displayed on the moving path 502U is presented by an image of an arrow pointing up. The target 302R displayed on the moving path 502R is presented by an image of an arrow pointing right.

A horizontal benchmark line 504 is displayed in the upper unit of the screen 500. Still marks 301 are displayed near the intersections between the benchmark line 504 and moving paths 502. The still marks 301 are presented by arrow images like the targets 302. The arrows point up, down, left or right. The still mark 301L is displayed near the intersection between the moving path 502L and benchmark line 504 and presented by an image of an arrow pointing left. The still mark 301D is displayed near the intersection between the moving path 502D and benchmark line 504 and presented by an image of an arrow pointing down. The still mark 301U is displayed near the intersection between the moving path 502U and benchmark line 504 and presented by an image of an arrow pointing up. The still mark 301R is displayed near the intersection between the moving path 502R and benchmark line 504 and presented by an image of an arrow pointing right.

Both the benchmark line 504 and the still marks 301 indicate the time for the player to press the buttons 202. As described above, the still marks 301 are displayed on the moving paths 502. The targets 302 move up on the screen 500 from the bottom to the top. The player watches the targets 302 move. Then, when a target 302 reaches and overlaps with a still mark 301, the player presses the button 202 corresponding to the direction of the arrow of the still mark 301. Here, the player can watch the benchmark line 504 and press the buttons 202 without checking on the still mark 301.

Here, it is assumed that the distance between the bottom end of the screen 500 and the benchmark line 504 is H, the distance over which each target 302 moves in a unit screen update is v, and the time period from the start of the game to the start time, tsta, of a record 402 is T. The target 302 corresponding to the record 402 is displayed at the bottom of the screen in the step T−H/v. Subsequently, the target 302 is displayed at a height of v(t−T)+H above the bottom end of the screen 500 after t steps since the start of the game.

After the target 302 passes the benchmark line 504, it moves over a constant distance v in one screen update. In other words, the target 302 is displayed in the manner that it moves over a distance v in one screen update. Assuming that the distance between the benchmark line 504 and the top end of the screen 500 is K, the target 302 will disappear after T+K/v steps since the start of the game.

The CPU 101 scans the records 402 in the table 401 for a target 302 currently to be displayed. In the above example, the target 302 corresponding to the record 402 satisfying T−H/v≦t≦T+K/v is displayed on the moving path 502 corresponding to the operation input type 404.

The target 302 is positioned at a height of v(t−T)+H above the bottom end of the screen 500.

Here, the timing of implementing operation input will be described with reference to FIG. 5B. Assuming that d=Tpre+Tplay, the target 302L reaches the benchmark line 504 at a time t=T. Furthermore, at a time t=T+d, the target 302L leaves the benchmark line 504. Therefore, if operation input is implemented between the time t=T and the time t=T+d, a score is earned. Here, it is assumed that the still mark 301L has the gravity center on the benchmark line 504 and the target 302L completely overlaps with the still mark 301L at a time t=T+Tpre. Then, as shown in FIG. 5B, a higher score is added as h is smaller in which h is the distance between the gravity center of the target 302L and the benchmark line 504. Here, h is proportional to the time difference, Tsub, between the time t=T+Tpre and the time of implementation of operation input. Therefore, a higher score is added as the time difference, Tsub, is smaller.

For example, a score of 500 may be added when the time difference, Tsub, is 1/60 second or smaller; a score of 200 may be added when the time difference, Tsub, is within a range between ( 1/60) and ( 3/60); a score of 100 may be added when the time difference, Tsub, is within a range between ( 3/60) and ( 5/60). Here, in this embodiment, the sound volume is increased when the operation input is determined to be successful. Then, in this embodiment, the sound volume is increased as the time difference, Tsub, is smaller. The determination result of operation input and the score are separated from each other in concept.

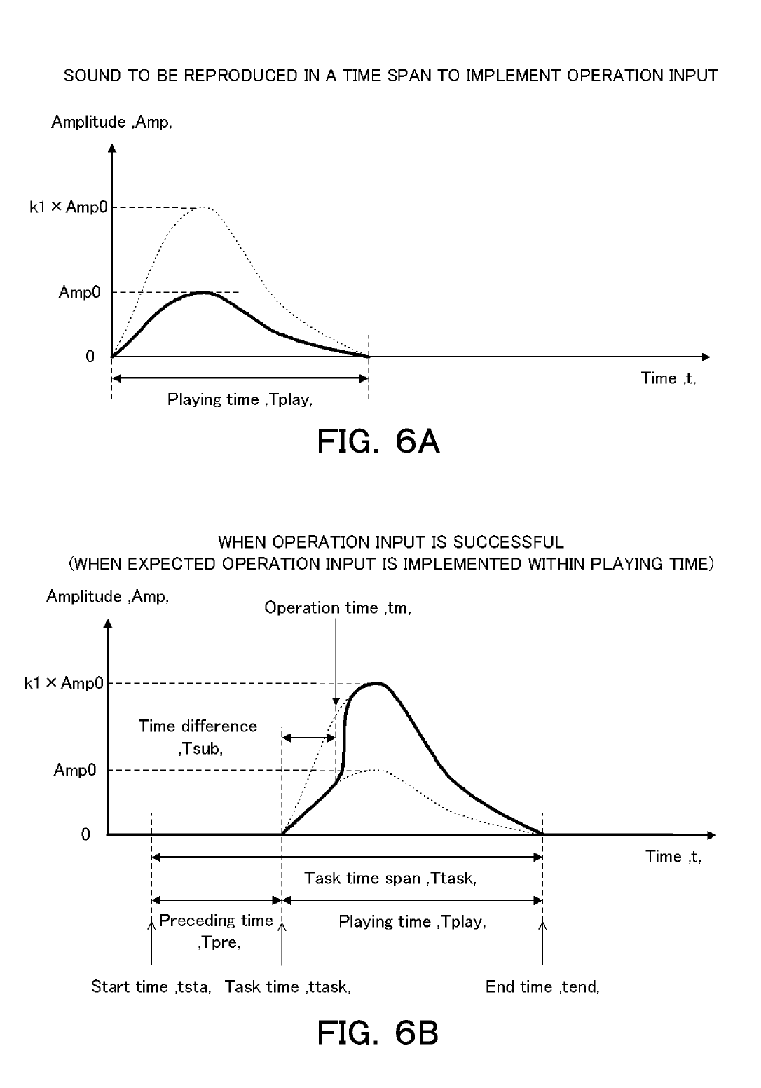

How the sound volume is changed according to the determination result of operation input will be described hereafter with reference to FIGS. 6A and 6B.

First, as a prerequisite, sound reproduced since a task time (“the task time indication sound”) will be described. The task time indication sound is obtained by converting a sound data column stored in a DVD-ROM or the like in advance to analog signals. The task time indication sound is sound output from a speaker described later when the analog signals are supplied to the speaker. The initial values of the loudness (amplitude), pitch (basic frequency), and tone (frequency profile) of the task time indication sound are determined by the sound data column. Here, the gaming device of this embodiment changes the volume of the task time indication sound output from the speaker. Therefore, the gaming device of this embodiment changes the loudness (amplitude) of the task time indication sound. Here, the gaming device of this embodiment may change the pitch or tone of the task time indication sound. Any method of changing the volume of the task time indication sound can be used. For example, the gaming device can change the signal level (amplitude) of the analog signals and supply them to the speaker. Alternatively, for example, the gaming device may change the signal level of signals presenting a sound volume and supplies the signals presenting a sound volume to the speaker together with the analog signals. The speaker reproduces the sound presented by the analog signals in a sound volume according to the signal level of the signals presenting a sound volume. For the purpose of explanation, the gaming device of this embodiment changes the signal level of analog signals and supplies them to the speaker. In the following explanation, the expression “to change the signal level of analog signals presenting the task time indication sound” is substituted by the expression “to change the volume of the task time indication sound” where appropriate.

The task time indication sound before the volume is changed will be described hereafter with reference to FIG. 6A. FIG. 6A is a graphical expression showing the relationship between the time, t, and the amplitude, Amp, indicating the volume of the task time indication sound. In FIG. 6A, the playing time, Tplay, is the time period during which the task time indication sound is reproduced. For example, it is assumed that the task time indication sound starts to be output at a time 0. As shown by the solid line in FIG. 6A, the task time indication sound is reproduced with given amplitudes during the playing time, Tplay. Here, it is assumed that the maximum value of the amplitude, Amp, of the task time indication sound is a basic maximum amplitude, Amp0. Here, the relationship between the time, t, and amplitude, Amp, when the sound volume is increased by a factor of k1 (k1 is a positive number) is shown by a dotted line in FIG. 6A. As shown by the dotted line in FIG. 6A, as the sound volume is increased by a factor of k1, the amplitude, Amp, is increased by a factor of k1 at any time, t, while the task time indication sound is reproduced.

How the task time indication sound volume is changed when operation input is determined to be successful will be described hereafter with reference to FIG. 6B. Here, explanation will be omitted for the symbols that have been described above in relation to FIG. 6A. A task time span, Ttask, is a time span to implement operation input. In other words, when expected operation input is implemented within a task time span, Ttask, the operation input is determined to be successful. Otherwise, the operation input is determined to be unsuccessful. Here, expected operation input is considered to be implemented, for example, in one of the following cases.

(1) Any of the buttons 202 is pressed: this mode is suitable for urging a beginner to press a button in time with the rhythm. In this embodiment, the player can know whether he/she is in time with the rhythm from the sound as long as the timing is right even if a wrong button is pressed. Therefore, no score may be given even though the operation input is determined to be successful.

(2) A button to be pressed is pressed among the buttons 202: this mode is suitable for letting a skilled player know whether the operation input is accurate by the sound. In this mode, when the operation input is determined to be successful, typically, a score corresponding to the time difference, Tsub, is earned.

Here, the task time, ttask, is the time after a preceding time, Tpre, elapses since the start time, tsta. The end time, tend, is the end time of the task time span, Ttask. In this embodiment, the task data 400 (the start time, tsta, preceding time, Tpre, and playing time, Tplay,) are determined so that the end time, tend, is equal to the time after the preceding time, Tpre, elapses since the start time, tsta. The time difference, Tsub, is the time difference between the task time, ttask, and operation time, tm. The operation time, tm, is the time when operation input is implemented.

As shown in FIG. 6B, the amplitude, Amp, is zero until the time, t, passes the task time, ttask. The task time indication sound has amplitudes, Amp, of predetermined values from the task time, ttask, to the operation time, tm. The amplitude, Amp, is increased from the predetermined values by a factor of k1 from the time of implementation of operation input to the time when output of the task time indication sound ends, namely from the operation time, tm, to the end time, tend. Here, k1 is determined according to the time difference, Tsub. Then, the amplitude, Amp, is zero at and after the end time, tend.

As described above, in the gaming device according to this embodiment, the task time indication sound volume is changed according to the determination result of operation input.

(Configuration of the Gaming Device)

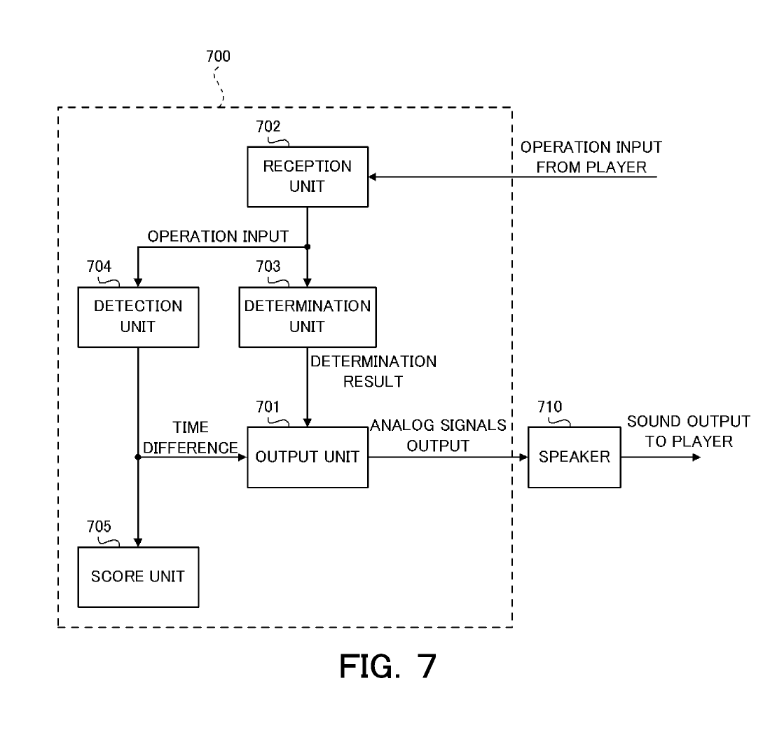

The configuration of the units of the gaming device of this embodiment will be described hereafter with reference to the drawings. FIG. 7 is a diagram for explaining the configuration of the gaming device according to this embodiment.

As shown in FIG. 7, a gaming device 700 according to this embodiment comprises an output unit 701, a reception unit 702, a determination unit 703, a detection unit 704, and a score unit 705.

The output unit 701 starts to output the task time indication sound from a task time, ttask. More specifically, the output unit 701 first generates analog signals for outputting the task time indication sound from a speaker 710. Then, the output unit 701 outputs the generated analog signals to the speaker 710. The speaker 710 outputs the task time indication sound according to the analog signals supplied from the output unit 701. The output unit 701 is realized by the CPU 101, sound processing unit 110, RTC 111, etc.

The reception unit 702 receives operation input from the player. The reception unit 702 is realized by the mat type controller 105, etc.

The determination unit 703 determines whether the operation time, tm, is included in the task time span, Ttask. As described above, the operation time, tm, is the time when operation input is received. The task time span, Ttask, includes the task time, ttask. The determination unit 703 is realized by the CPU 101, RTC 111, etc.

The detection unit 704 detects the time difference, Tsub, between the operation time, tm, and task time, ttask. The detection unit 704 is realized by the CPU 101, RTC 111, etc. The detection unit 704 can be omitted where appropriate.

The score unit 705 accumulates scores corresponding to the time difference, Tsub, detected by the detection unit 704. The score unit 705 is realized by the CPU 101, etc. The score unit 705 can be omitted where appropriate.

Here, the output unit 701 changes the task time indication sound volume output since the task time, ttask, in accordance with the determination result by the determination unit 703.

More specifically, first, the output unit 701 generates analog signals for outputting the task time indication sound from the speaker 710. Here, the task time indication sound volume depends on the determination result. Then, the output unit 701 outputs the generated analog signals to the speaker 710. In other words, the output unit 701 changes the task time indication sound volume according to the determination result. Here, the output unit 701 may change the task time indication sound volume according to the time difference detected by the detection unit 704. Here, the output unit 701 may further change the pitch or tone of the task time indication sound according to the determination result.

(Operation of the Gaming Device)

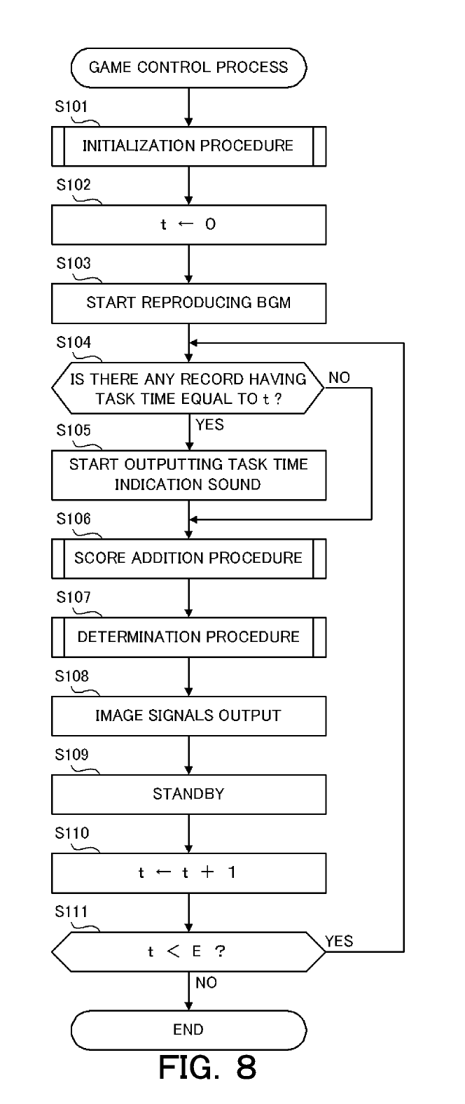

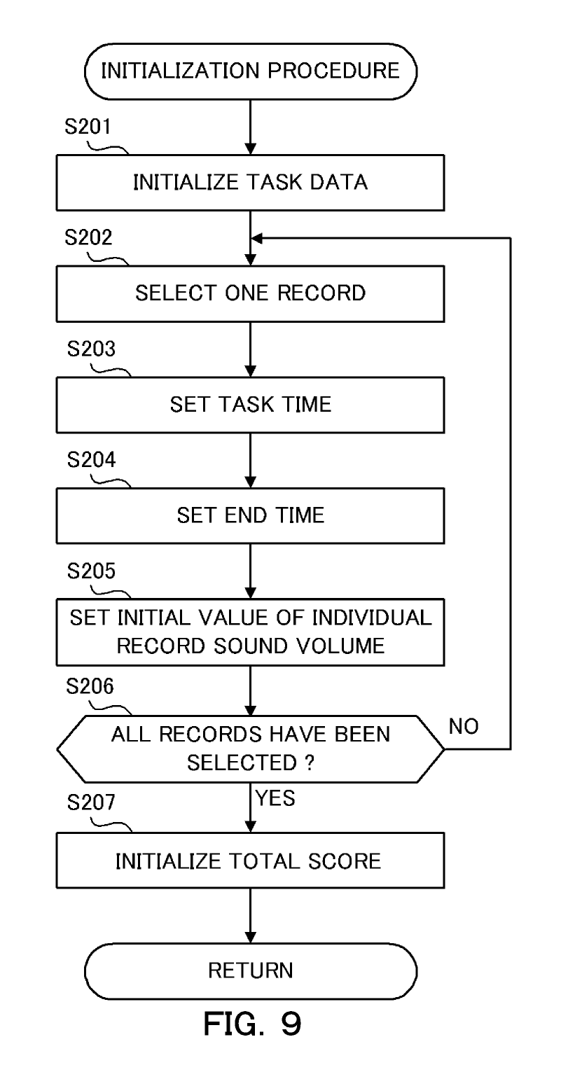

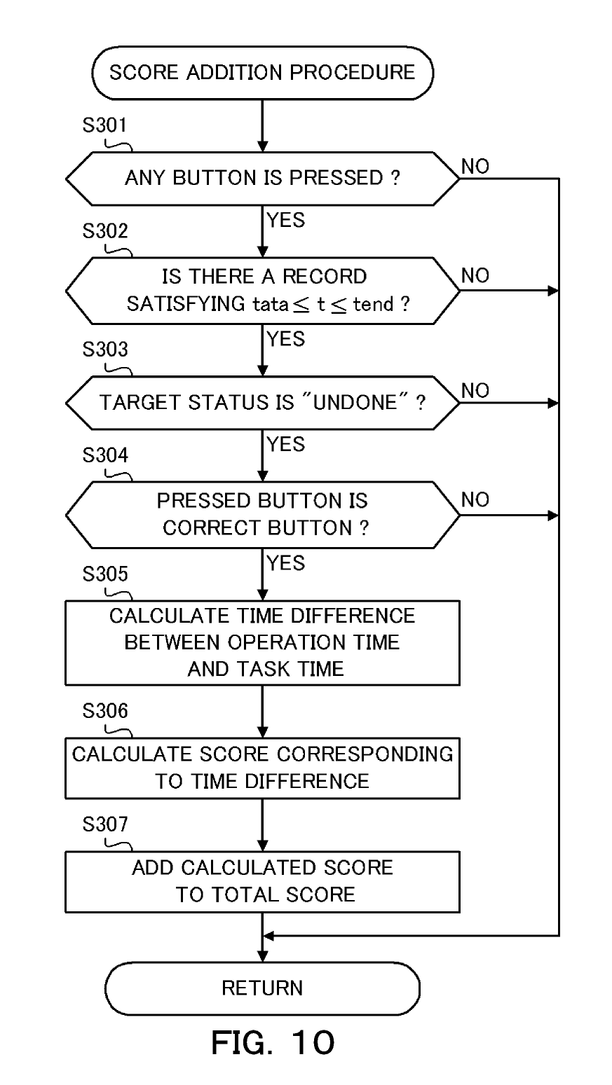

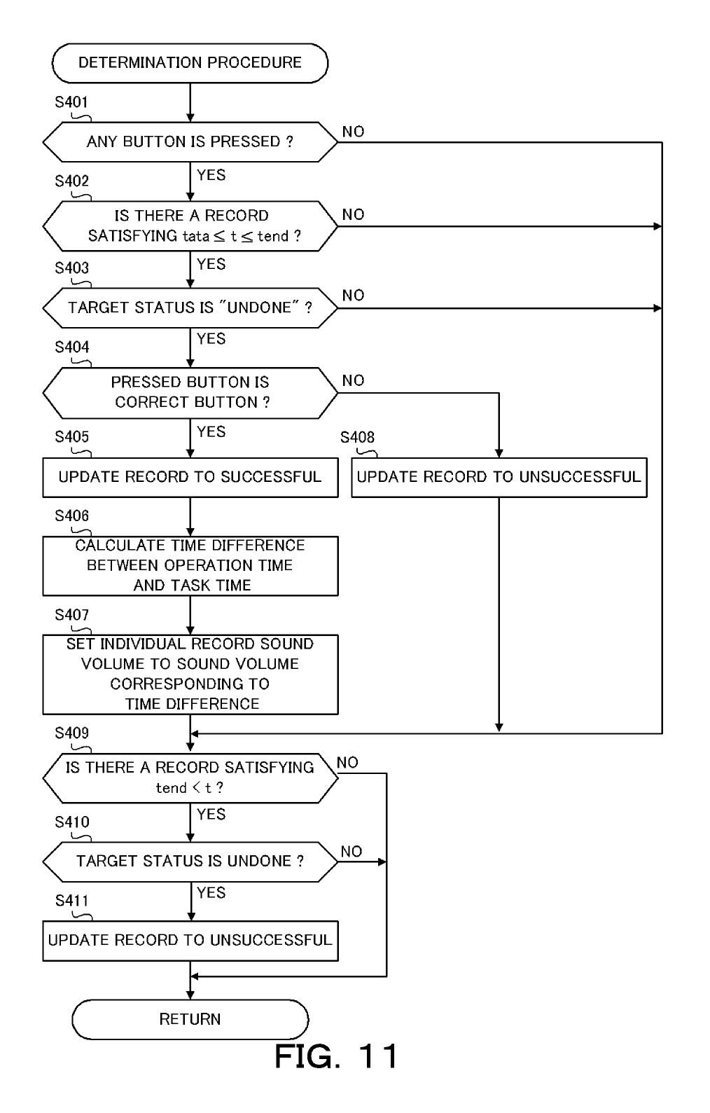

Operation of the gaming device 700 according to this embodiment will be described hereafter with reference to FIGS. 8 to 11. FIG. 8 is a flowchart of the game control process executed by the gaming device 700 according to this embodiment. FIG. 9 is a flowchart of the initialization procedure executed by the gaming device 700 according to this embodiment. FIG. 10 is a flowchart of the score addition procedure executed by the gaming device 700 according to this embodiment. FIG. 11 is a flowchart of the determination procedure executed by the gaming device 700 according to this embodiment. Here, the gaming device 700 determines that operation input is successful when a button to be pressed (“the correct button” hereafter) among the buttons 202 is pressed within the task time span, Ttask. The gaming device 700 determines that operation input is unsuccessful when a button not to be pressed (“a wrong button” hereafter) among the buttons 202 is pressed within the task time span, Ttask. Furthermore, the gaming device 700 determines that operation input is unsuccessful when no button is pressed within the task time span, Ttask. Then, the gaming device 700 increases the sound volume when operation input is determined to be successful. The gaming device 700 maintains the sound volume when operation input is determined to be unsuccessful. The gaming device 700 adds a score corresponding to the time difference, Tsub, to the total score when the correct button is pressed within the task time span, Ttask.

As task music is selected through operation input from the player, the CPU 101 executes an initialization procedure (Step S101). The initialization procedure will be described with reference to the flowchart shown in FIG. 9.

First, the CPU 101 reads task data 400 from a DVD-ROM onto a given task data region of the RAM 103 for initialization (Step S201). The initial values of the task data 400 are stored in a DVD-ROM mounted on the DVD-ROM drive 108.

Then, the CPU 101 selects one of the records 402 (Step S202).

Then, the CPU 101 sets the task time, ttask, (Step S203). Here, the task time, ttask, is set to the time after the preceding time, Tpre, elapses since the start time, tsta. As described above, the start time, tsta, is included in the record 402 selected in the Step S202. The task time, ttask, is stored in the RAM 103 in association with the record 402 selected in the Step S202.

Furthermore, the CPU 101 sets the end time, tend, (Step S204). Here, the end time, tend, is set to the time after the playing time, Tplay, elapses since the task time, ttask, set in the Step S203. The end time, tend, is stored in the RAM 103 in association with the record 402 selected in the Step S202. Here, the task time span, Ttask, is the time span from the start time, tsta, to the end time, tend. Therefore, with the end time, tend, being set, the task time span, Ttask, is set.

Furthermore, the CPU 101 sets the initial value of an individual record sound volume Vol (Step S205). The individual record sound volume Vol varies depending on the record. The individual record sound volume Vol indicates the sound volume of the sound data column reproduced from the task time, ttask, for each record. The individual record sound volume Vol is set in association with the record 402 selected in the Step S202. In other words, the individual record sound volume Vol is stored in the RAM 103 in association with the record 402 selected in the Step S202. The sound processing unit 110 starts to generate analog signals presenting the task time indication sound and supply them to the speaker 710 since the task time, ttask. Here, the sound processing unit 110 changes the signal level of the analog signals according to the individual record sound volume Vol. The individual record sound volume Vol is associated with the record 402 to which the task time, ttask, corresponds. Therefore, the CPU 101 can change the task time indication sound volume output from the speaker 107 by properly changing the individual record sound volume Vol. Here, in the step S205, a basic sound volume Vol 0, which is the initial value of an individual record sound volume Vol, is set to a predetermined value in advance.

Then, the CPU 101 determines whether all records have been selected in the Step S202 (Step S206). If all records have been selected (Step S206: YES), the CPU 101 initializes the total score to zero (Step S207) and ends the initialization procedure. On the other hand, if any record has not been selected (Step S206; NO), the CPU 101 returns to the step of selecting a record (Step S202).

In this embodiment, the start time, tsta, end time, tend, task time span, Ttask, task time, ttask, playing time, Tplay, preceding time, Tpre, and time difference, Tsub, are all presented by a numeric value in units of the above-mentioned number of times of screen update (a numeric value in units of a vertical synchronizing interrupt cycle (typically, 1/60 second)).

Returning to FIG. 8, the CPU 101 initializes the current number of times of screen update (which is presented by t) among variable regions of the RAM 103 to zero (Step S102). The number of times of screen update is increased by one for each vertical synchronizing interrupt. The number of times of screen update corresponds to the above-described time, t.

Then, the CPU 101 instructs the sound processing unit 110 to start to reproduce BGM associated with the task data 400 (Step S103). The BGM sound data column is recorded on the DVD-ROM in the format of PCM (pulse code modulation), MP3 (MPEG layer 3), Ogg Vorbis, MIDI (musical instrument digital interface), or the like.

Then, the CPU 101 scans the records 402 in the table 401 and determines whether that is a record 402 having the task time, ttask, equal to t (Step S104). If there is a record 402 having the task time, ttask, equal to t (Step S104; YES), the CPU 101 starts to output the task time indication sound (Step S105). More specifically, the CPU 101 instructs the sound processing unit 110 to reproduce the sound data column stored in the DVD-ROM in advance. The sound data column is stored in the DVD-ROM in various formats in advance like the BGM sound data column. Here, it is desirable that the CPU 101 reads the sound data column onto the RAM 103 in advance for faster processing. In such a case, the sound data column can be stored in a format allowing for a smaller data volume such as MIDI.

In this embodiment, the BGM sound data column and records 402 are created in the manner that the task time, ttask, associated with each record 402 matches the rhythm of BGM associated with the task data 400. Therefore, the task time indication sound is reproduced at each task time, ttask, in time with the rhythm of BGM regardless of when the player implements operation input.

If there is no record 402 having the task time, ttask, equal to t (Step S104; NO) or after the task time indication sound starts to be output (Step S105), the CPU 101 executes a score addition procedure (Step S106). The score addition procedure will be described in detail with reference to the flowchart shown in FIG. 10.

First, the CPU 101 determines whether any of the buttons 202 of the mat type controller 105 is pressed (Step S301). If any button is pressed (Step S301; YES), the CPU 101 scans the records 402 in the table 401. Then, the CPU 101 determines whether there is a record with which the start time, tsta, t (the number of times of screen update), and end time, tend, satisfies tsta≦t≦tend (Step S302).

If there is a record 402 satisfying tsta≦t≦tend (Step S302; YES), the CPU 101 determines whether the target status 405 is “undone” (Step S303). Then, if the target status 405 is “undone” (Step S303; YES), the CPU 101 determines whether the pressed button is the correct button (Step S304). More specifically, the CPU 101 determines whether the operation input type 404 of the record 402 is equal to the type of the pressed button 202.

If the pressed button is the correct button (Step S304; YES), the CPU 101 calculates the time difference, Tsub, between the operation time, tm, and task time, ttask, (Step S305). Then, the CPU 101 calculates a score corresponding to the time difference, Tsub, (Step S306) and adds the calculated score to the total score (Step S307).

The CPU ends the score addition procedure when any of the following conditions is satisfied: (a) the CPU 101 determines that no button is pressed (Step S301; NO); (b) the CPU 101 determines that there is no record 402 satisfying tsta≦t≦tend (Step S302; NO); (c) the CPU 101 determines that the target status 405 is not “undone” (Step S303; NO); (d) the CPU 101 determines that the pressed button is not the correct button (Step S304; NO); or (e) the CPU 101 has completed the procedure to add the calculated score to the total score (Step S307).

After completing the score addition procedure (Step S106), the CPU 101 executes a determination procedure (Step S107). The determination procedure will be described in detail with reference to the flowchart shown in FIG. 11.

First, the CPU 101 determines whether any of the buttons 202 of the mat type controller 105 is pressed (Step S401). If any button is pressed (Step S401; YES), the CPU 101 scans the records 402 in the table 401. Then, the CPU 101 determines whether there is a record 402 satisfying tsta≦t≦tend (Step S402).

If there is a record 402 satisfying tsta≦t≦tend (Step S402; YES), the CPU 101 determines whether the target status 405 is “undone” (Step S403). Then, if the target status 405 is “undone” (Step S403; YES), the CPU 101 determines whether the pressed button is the correct button (Step S404).

If the pressed button is the correct button (Step S404; YES), the CPU 101 updates the target status 405 of the record 402 to “successful” (Step S405). Then, the CPU 101 calculates the time difference, Tsub, between the operation time, tm, and task time, ttask, (Step S406), and sets the individual record sound volume Vol to a volume corresponding to the time difference, Tsub, (Step S407).

Here, the individual record sound volume Vol associated with the record 402 that was determined to be successful is set in accordance with the time difference, Tsub. More specifically, as the time difference, Tsub, is smaller, the individual record sound volume Vol is increased. As the time difference, Tsub, is larger, the individual record sound volume Vol is decreased. However, the individual record sound volume Vol is not lower than the initial value set in the Step S205 even if the time difference Tsu is large. For example, the individual record sound volume Vol is set in the manner that Vol=Vol 0+k1×(Tpre−Tsub)/Tpre when Tpre>Tplay, and Vol=Vol 0+k1×(Tplay−Tsub)/Tplay when Tpre<Tplay in which k1 is a positive number.

On the other hand, if the pressed button is not the correct button (Step S404; NO), the CPU 101 updates the target status 405 of the record 402 to “unsuccessful” (Step S408).

The CPU 101 proceeds to Step S409 when any of the following conditions is satisfied: (a) the CPU 101 determines that no button is pressed (Step S401; NO); (b) the CPU 101 determines that there is no record 402 satisfying tsta≦t≦tend (Step S402; NO); (c) the CPU 101 determines that the target status 405 is not “undone” (Step S403; NO); (d) the CPU 101 has completed the procedure to update the record to unsuccessful (Step S408); or (e) the CPU 101 has completed the procedure to set the individual record sound volume Vol to a sound volume corresponding to the time difference (Step S407).

Then, the CPU 101 scans the records 402 in the table 401. Then, the CPU 101 determines whether there is a record 402 satisfying tend<t (Step S409). If there is a record 402 satisfying tend<t (Step S409; YES), the CPU 101 determines whether the target status 405 is “undone” (Step S410). Then, if the target status 405 is “undone” (Step S410; YES), the CPU 101 updates the target status 405 of the record 402 to “unsuccessful” (Step S411).

When any of the following conditions is satisfied, the CPU 101 ends the determination procedure and outputs image signals (Step S108): (a) it is determined that there is no record 402 satisfying tend<t (Step S409; NO); (b) it is determined that the target status 405 is not “undone” (Step S410; NO); or (c) the procedure to update the record 402 to unsuccessful is completed (Step S411).

Then, the CPU 101 controls the image processing unit 107 to output signals for displaying the target 302, still marks 301, and benchmark line 504 on the monitor (not shown) (Step S108).

After completing the procedure to output the generated image signals (Step S108), the CPU 101 becomes on standby until next vertical synchronization (Step S109). During the standby, the CPU 101 may execute other procedures. When next vertical synchronizing interrupt occurs, the CPU 101 increases t (Step S110). Then, the CPU 101 repeats the Steps S104 to S110 until t reaches E associated with the task (the play end time 421) (Step S111; YES). In other words, the CPU 101 returns to the Step S104 unless t reaches E (the play end time 421) (Step S111; YES).

At the time t=E, the playing of BGM just ends. In other words, the start time, tsta, in any record 402 is earlier than E (the play end time 421). When t reaches E (the play end time 421), the gaming device 700 ends the game control process.

The relationship between the time, t, and amplitude, Amp, will be described hereafter with reference to the drawings.

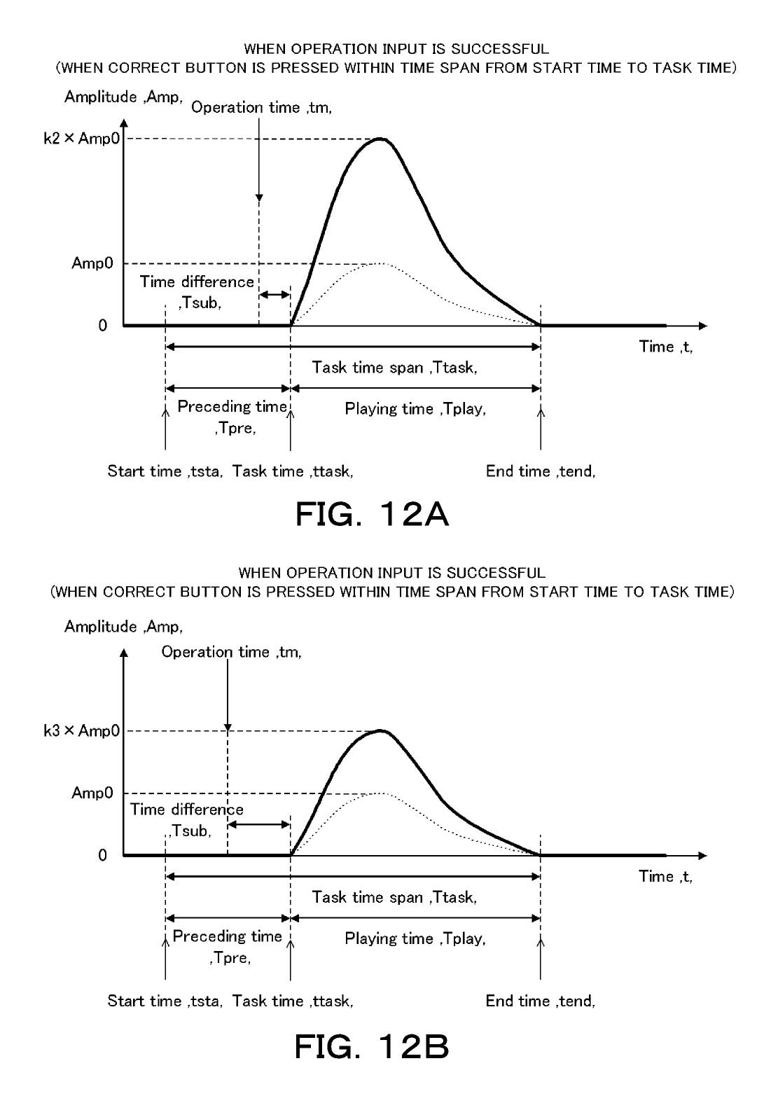

FIG. 12A is a graphical representation showing the relationship between the time, t, and amplitude, Amp, when the correct button is pressed in the time span from the start time, tsta, to the task time, ttask, and the operation input is successful. When the correct button is pressed in the time span from the start time, tsta, to the task time, ttask, the operation input is determined to be successful. Then, the time difference T sub between the operation time, tm, and task time, ttask, is calculated in the Step S406. Then, in the Step S407, the individual record sound volume Vol is set in accordance with the time difference, Tsub. Here, it is assumed that the individual record sound volume Vol is set to a sound volume increased from the basic sound volume Vol 0 by a factor of k2 (k2 is a positive number). Then, when t reaches the task time, ttask, (the time when YES is ruled in the Step S104), the individual record sound volume Vol is set to a sound volume increased from the basic sound volume Vol 0 by a factor of k2. Therefore, the task time indication sound starts to be output in a sound volume increased from the basic sound volume Vol 0 by a factor of k2 in the Step S105. In this way, the task time indication sound is reproduced in a sound volume increased by a factor of k2 after the task time, ttask.

FIG. 12B is a graphical representation showing the relationship between the time, t, and amplitude, Amp, when the correct button is pressed in the time span from the start time, tsta, to the task time, ttask, and the operation input is successful. The time difference, Tsub, between the operation time, tm, and task time, ttask, is larger in the example of FIG. 12B than in the example of FIG. 12A. Here, it is assumed that the individual record sound volume Vol is set to a sound volume increased from the basic sound volume Vol 0 by a factor of k3 (k3 is a positive number lower than k2). Then, the task time indication sound is reproduced in a sound volume increased by a factor of k3 after the task time, ttask.

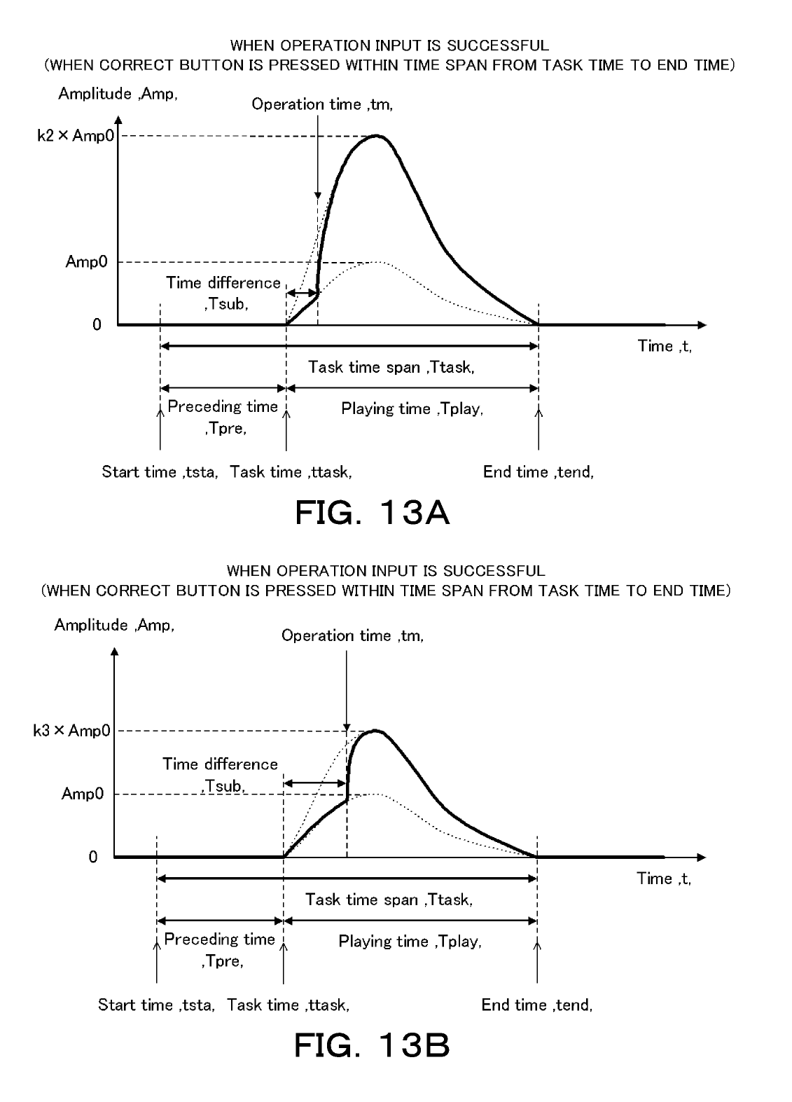

FIG. 13A is a graphical representation showing the relationship between the time, t, and amplitude, Amp, when the correct button is pressed in the time span from the task time, ttask, to the end time, tend, and the operation input is successful. When the correct button is pressed in the time span from the task time, ttask, to the end time, tend, the operation input is determined to be successful. Then, the time difference, Tsub, between the operation time, tm, and task time, ttask, is calculated in the Step S406. Then, in the Step S407, the individual record sound volume Vol is set in accordance with the time difference, Tsub. Here, it is assumed that the individual record sound volume Vol is set to a sound volume increased from the basic sound volume Vol 0 by a factor of k2. However, the operation input is not determined to be successful and the individual record sound volume Vol is maintained at the initial value until the operation time, tm. In other words, when t reaches the task time, ttask, (the time when YES is ruled in the Step S104), the individual record sound volume Vol is maintained at the basic sound volume Vol 0. On the other hand, at the operation time, tm, the individual record sound volume Vol is set to a sound volume increased from the basic sound volume Vol 0 by a factor of k2 in the Step S407. Therefore, the task time indication sound having the amplitude, Amp, is reproduced without being amplified from the task time, ttask, to the operation time, tm. Then, the task time indication sound is reproduced in a sound volume increased by a factor of k2 from the operation time, tm, to the end time, tend.

FIG. 13B is a graphical representation showing the relationship between the time, t, and amplitude, Amp, when the correct button is pressed in the time span from the task time, ttask, to the end time, tend, and the operation input is successful. The time difference, Tsub, between the operation time, tm, and task time, ttask, is larger in the example of FIG. 13B than in the example of FIG. 13A. Here, it is assumed that the individual record sound volume Vol is set also to a sound volume increased from the basic sound volume Vol 0 by a factor of k3. Then, the task time indication sound is reproduced in the unamplified amplitude, Amp, from the task time, ttask, to the operation time, tm. Then, the task time indication sound is reproduced in a sound volume increased by a factor of k3 from the operation time, tm, to the end time, tend.

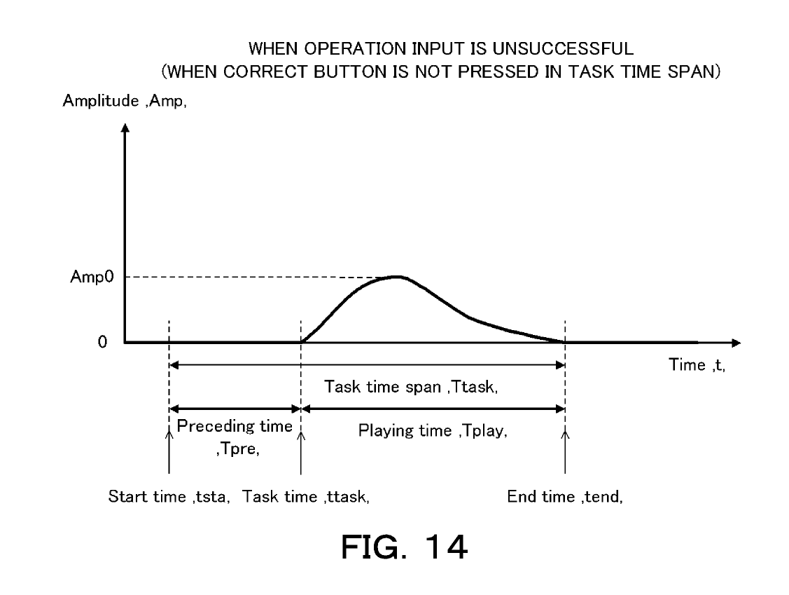

FIG. 14 is a graphical representation showing the relationship between the time, t, and amplitude, Amp, when the correct button is not pressed in the task time span, Ttask, and the operation input is unsuccessful. When the correct button is not pressed in the task time span, Ttask, the operation input is determined to be unsuccessful. In such a case, the individual record sound volume Vol is maintained at the basic sound volume Vol 0. Therefore, the sound volume of the task time indication sound having started to be output in the basic sound volume Vol 0 in the Step S105 is unchanged. Then, the task time indication sound is reproduced with the unamplified amplitude, Amp, in the time span from the task time, ttask, to the end time, tend. Here, the same relationship between the time, t, and amplitude, Amp, as shown in FIG. 14 applies to the case of operation input being unsuccessful. In other words, the same relationship between the time, t, and amplitude, Amp, as shown in FIG. 14 applies to the case of a wrong button being pressed in the task time span, Ttask. This is because in this embodiment, the individual record sound volume Vol is maintained at the basic sound volume Vol 0 when the operation input is determined to be unsuccessful.

The gaming device 700 according to this embodiment outputs given sound at times to implement operation input in time with the rhythm of music. The given sound is output regardless of the presence/absence or time of operation input. Furthermore, the output sound volume is changed according to the presence/absence of operation input, operation input type, and operation input time. Consequently, the player can know the operation input determination result by sound in a timely manner in time with the rhythm of music.

### Modified Embodiment 1

The present invention is not confined to the above embodiment and various modifications can be made.

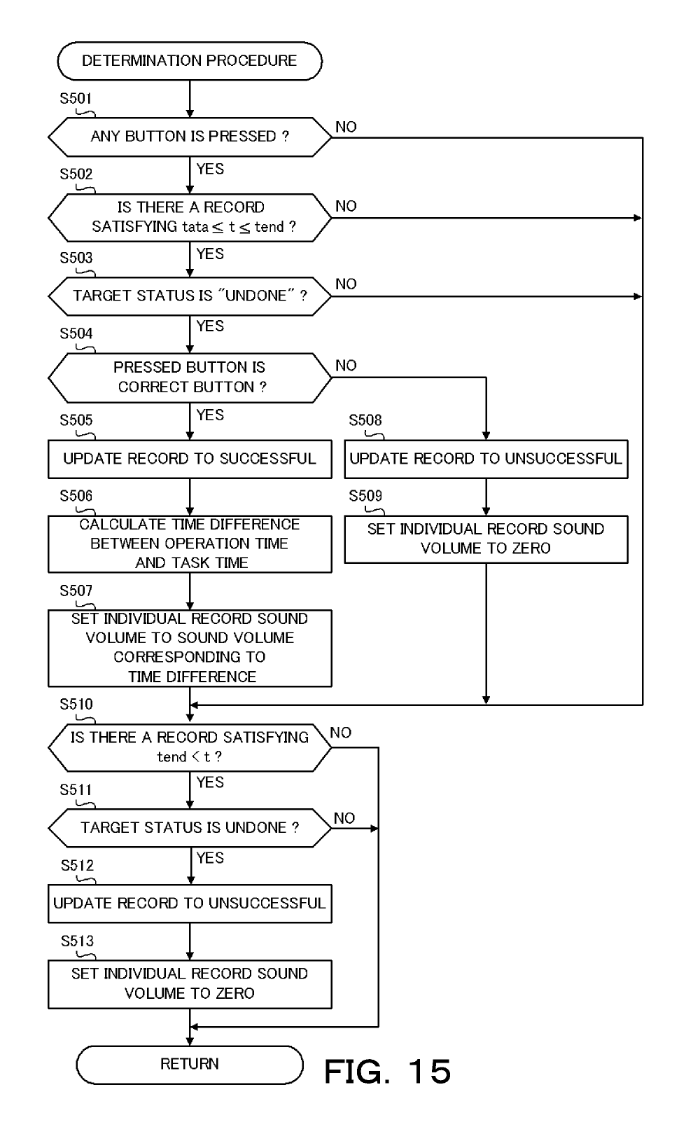

In the above embodiment, the task time indication sound is reproduced in the basic sound volume Vol 0 even if the operation input is determined to be unsuccessful. However, the task time indication sound does not need to be output when the operation input is determined to be unsuccessful. The game control process of the gaming device 700 according to Modified Embodiment 1 will be described hereafter. The game control process except for the determination procedure is the same as that in the above embodiment. Therefore, the determination procedure executed by the gaming device 700 according to Modified Embodiment 1 will be described hereafter with reference to FIG. 15.

First, the CPU 101 determines whether any of the buttons 202 of the mat type controller 105 is pressed (Step S501). If any button is pressed (Step S501; YES), the CPU 101 scans the records 402 in the table 401. Then, the CPU 101 determines whether there is a record 402 satisfying tsta≦t≦tend (Step S502).

If there is a record 402 satisfying tsta≦t≦tend (Step S502; YES), the CPU 101 determines whether the target status 405 is “undone” (Step S503). Then, if the target status 405 is “undone” (Step S503; YES), the CPU 101 determines whether the pressed button is the correct button (Step S504).

If the pressed button is the correct button (Step S504; YES), the CPU 101 updates the target status 405 of the record 402 to “successful” (Step S505). Then, the CPU 101 calculates the difference, Tsub, between the operation time, tm, and task time, ttask, (Step S506) and sets the individual record sound volume Vol to a sound volume corresponding to the time difference, Tsub, (Step S507).

On the other hand, if the pressed button is not the correct button (Step S504; NO), the CPU 101 updates the target status 405 of the record 402 to “unsuccessful” (Step S508). Then, the CPU 101 sets the individual record sound volume Vol to zero (Step S509). Here, if the individual record sound volume Vol is set to zero after the task time indication sound starts to be output, the output of the task time indication sound discontinues. On the other hand, if the individual record sound volume Vol is set to zero before the task time indication sound starts to be output, the task time indication sound is not output.

The CPU 101 proceeds to Step S510 when any of the following conditions is satisfied: (a) it is determined that no button is pressed (Step S501; NO); (b) it is determined that there is no record 402 satisfying tsta≦t≦tend (Step S502; NO); (c) it is determined that the target status 405 is not “undone” (Step S503; NO); (d) the procedure to set the individual record sound volume Vol to zero is completed (Step S509); or (e) the procedure to set the individual record sound volume Vol to a sound volume corresponding to the time difference, Tsub, is completed (Step S507).

Then, the CPU 101 scans the records 402 in the table 401 and determines whether there is a record 402 satisfying tend<t (Step S510). If there is a record 402 satisfying tend<t (Step S510; YES), the CPU 101 determines whether the target status 405 is “undone” (Step S511). Then, if the target status 405 is “undone” (Step S511; YES), the CPU 101 updates the target status 405 of the record 402 to “unsuccessful” (Step S512) and sets the individual record sound volume Vol to zero (Step S513).

The CPU ends the determination procedure when any of the following conditions is satisfied: (a) it is determined that there is no record 402 satisfying tend<t (Step S510; NO); (b) it is determined that the target status 405 is not “undone” (Step S511; NO); or (c) the procedure to set the individual record sound volume Vol to zero is completed (Step S513).

The relationship between the time, t, and amplitude, Amp, will be described hereafter with reference to the drawings. When the correct button is pressed within the task time span, Ttask, the same procedure as described above is executed. Therefore, the case in which a wrong button is pressed within the task time span, Ttask, will be described hereafter.

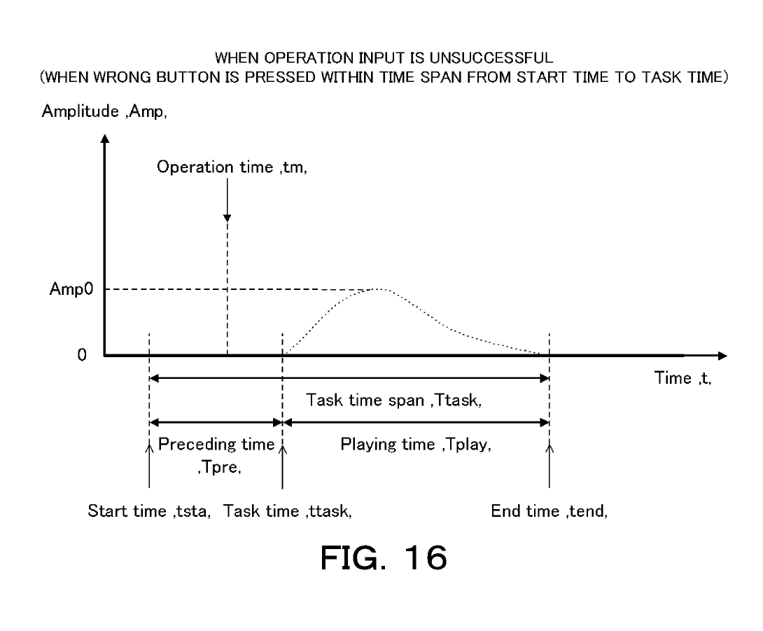

FIG. 16 is a graphical representation showing the relationship between the time, t, and amplitude, Amp, when a wrong button is pressed in the time span from the start time, tsta, to the task time, ttask, and the operation input is unsuccessful. When a wrong button is pressed in the time span from the start time, tsta, to the task time, ttask, the operation input is determined to be unsuccessful. Therefore, the individual record sound volume Vol is set to zero in the Step S509. The individual record sound volume Vol is set to zero before the task time, ttask. Generally, the task time indication sound starts to be reproduced at the task time, ttask. Therefore, when the individual record sound volume Vol is set to zero before the task time, ttask, the task time indication sound is not reproduced at and after the task time, ttask.

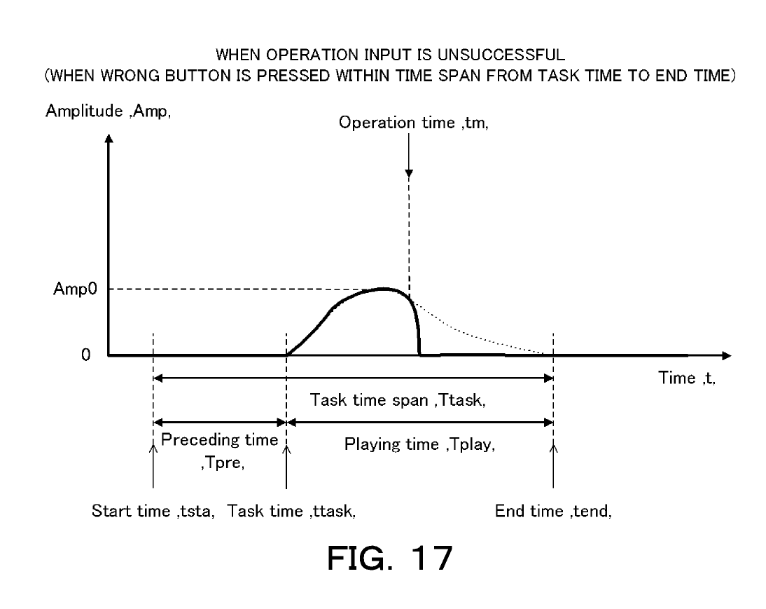

FIG. 17 is a graphical representation showing the relationship between the time, t, and amplitude, Amp, when a wrong button is pressed in the time span from the task time, ttask, to the end time, tend, and the operation input is unsuccessful. When a wrong button is pressed in the time span from the task time, ttask, to the end time, tend, the operation input is determined to be unsuccessful. Therefore, the individual record sound volume Vol is set to zero in the Step S509. Here, the individual record sound volume Vol is set to zero after the task time, ttask, at which the task time indication sound starts to be reproduced. Therefore, the task time indication sound is reproduced in the unamplified amplitude, Amp, from the task time, ttask, to the operation time, tm. Then, the reproduction of the task time indication sound discontinues at the operation time, tm.

The gaming device 700 according to Modified Embodiment 1 discontinues the output of sound when operation input is determined to be unsuccessful. Therefore, the player can know that the operation input was unsuccessful.

### Modified Embodiment 2

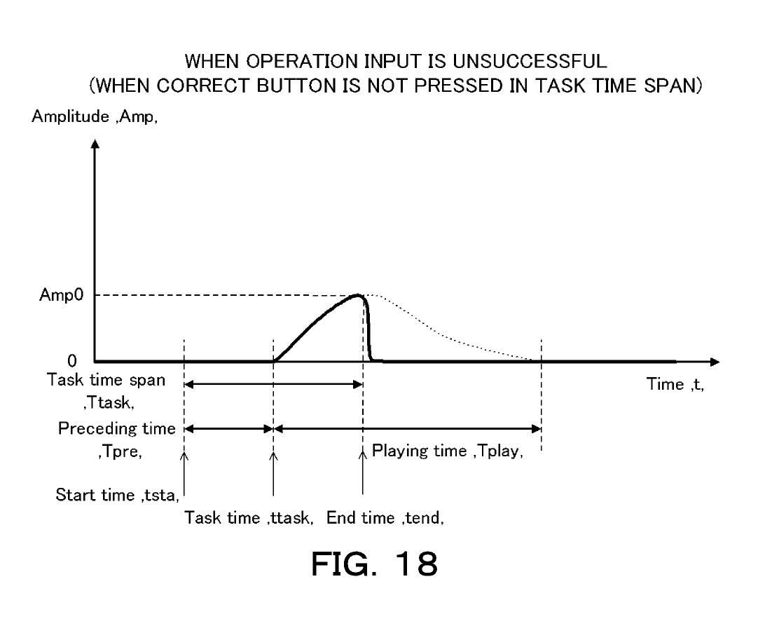

In the gaming device 700 according to the above Modified Embodiment 1, the time to end the reproduction of the task time indication sound is equal to the end time, tend. However, the time to end the reproduction of the task time indication sound can be later than the end time, tend. In this way, the playing time, Tplay, can be extended while keeping the task time span, Ttask, small. In such a case, the task time indication sound volume can be set to zero after operation input is determined to be unsuccessful. The relationship between the time, t, and amplitude, Amp, when the game control process is executed using the gaming device 700 according to Modified Embodiment 2 will be described hereafter with reference to FIG. 18. Here, when a wrong button is pressed within the task time span, Ttask, and the operation input is determined to be unsuccessful, the same procedure as in Modified Embodiment 1 is executed. Therefore, the case in which the correct button is not pressed within the task time span, Ttask, and the operation input is determined to be unsuccessful will be described hereafter.

FIG. 18 is a graphical representation showing the relationship between the time, t, and amplitude, Amp, when the correct button is not pressed within the task time span, Ttask, and the operation input is unsuccessful. When the correct button is not pressed within the task time span, Ttask, the operation input is determined to be unsuccessful. Therefore, the individual record sound volume Vol is set to zero in the procedure equivalent to the Step S513. Here, the individual record sound volume Vol is set to zero immediately after the end time, tend. Therefore, the task time indication sound is reproduced with the unamplified amplitude, Amp, from the task time, ttask, to the end time, tend. Then, the reproduction of the task time indication sound discontinues at the end time, tend.

The gaming device 700 according to Modified Embodiment 2 discontinues the output of sound when operation input is determined to be unsuccessful. Therefore, the player can know that the operation input was unsuccessful.

### Modified Embodiment 3

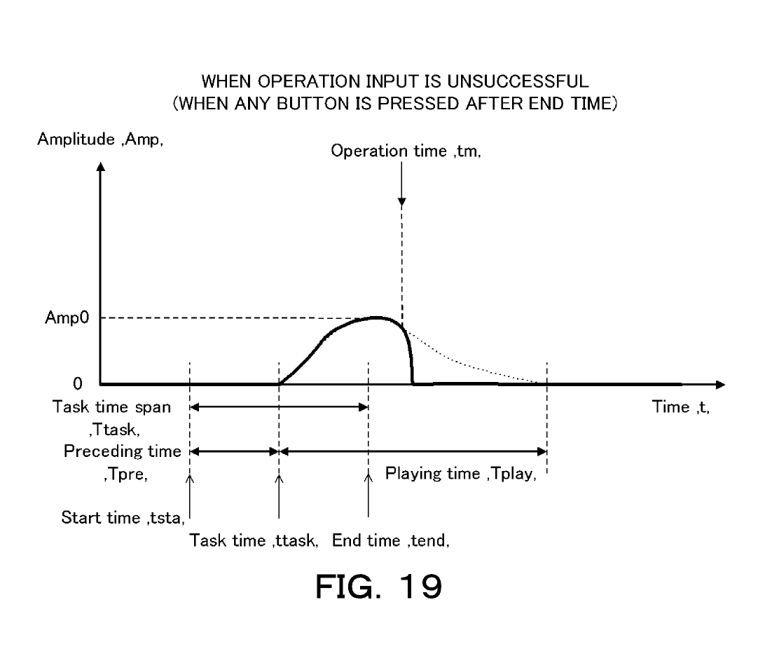

The gaming device 700 according to the above Modified Embodiment 2 immediately discontinues the output of sound when operation input is determined to be unsuccessful. However, the sound volume does not need to be changed immediately depending on the operation input determination result. For example, the sound output may be continued until any button is pressed after the end time, tend, even if the correct button is not pressed within the task time span, Ttask, and the operation input is determined to be unsuccessful. The relationship between the time, t, and amplitude, Amp, when the game control process is executed using the gaming device 700 according to Modified Embodiment 3 will be described hereafter with reference to FIG. 19.

FIG. 19 is a graphical representation showing the relationship between the time, t, and amplitude, Amp, when any button is pressed after the end time, tend. When the correct button is not pressed within the task time span, Ttask, and any button is pressed after the end time, tend, the operation input is determined to be unsuccessful. Here, if the task time indication sound is output, the task time indication sound volume can be changed to zero. In other words, the task time indication sound is reproduced with the unamplified amplitude, Amp, from the task time, ttask, to the operation time, tm. Then, after the operation time, tm, the task time indication sound volume becomes zero (the task time indication sound is not reproduced).

The gaming device 700 according to Modified Embodiment 3 can indicate that the operation input was unsuccessful by eliminating the sound. Here, the gaming device 700 according to Modified Embodiment 3 also outputs the task time indication sound from the task time, ttask, to the end time, tend, in any case.

In the above embodiments, the operation input is determined to be successful when the correct button is pressed within the task time span. Otherwise, the operation input is determined to be unsuccessful in the above embodiments. In the above embodiments, in the event that the correct button and a wrong button are pressed within the task time span, the operation input is determined to be successful if the button pressed first is the correct button. The operation input is determined to be unsuccessful if the button pressed first is a wrong button. However, the operation input determination method can be modified as appropriate. For example, the operation input can be determined to be successful when any button is pressed within the task time span. In such a case, the operation input is determined to be successful even if a wrong button is pressed within the task time span. If any button is pressed within the task time span, the pressing action is in time with the rhythm of music. In such a case, button type error is not the matter to the operation input determination. The sound output indicates appreciation of a button being pressed in time with music. Then, the player can play without losing the rhythm.

In the above embodiments, the score addition procedure and the determination procedure are separately executed. Therefore, there is some duplicated processing. However, the score addition procedure and determination procedure can be combined to eliminate the duplicated processing.

In the above Modified Embodiment 1 to 3, the gaming device 700 changes the sound volume to zero to let the player know that the operation input was unsuccessful. However, any technique including output of out-of-tune sound (change in the basic frequency) and change in sound pitch (change in the component ratio of frequency components) can be used to let the player know that the operation input was unsuccessful.

In the above embodiments, the present invention is applied to a dance game. However, the present invention is applicable to a wide range of applications including rhythm games in which the player implements operation input at indicated times.

This application claims the priority based on Japanese Patent Application No. 2009-073888, of which the entire content is incorporated herein by reference.

### INDUSTRIAL APPLICABILITY

As described above, the present invention can provide a gaming device, game control method, information recording medium, and program capable of outputting sound corresponding to operation input properly at indicated times in a game in which the player implements operation input at the indicated times.

### EXPLANATION OF REFERENCE NUMERALS

100 information processing device
101 CPU
102 ROM
104 interface
105 mat type controller
106 external memory
107 image processing unit
108 DVD-ROM drive
109 NIC
110 sound processing unit
111 RTC
202L, 202D, 202U, 202R button
301L, 301D, 301U, 301R still mark
302L, 302D, 302U, 302R target
400 task data
401 table
402 record
404 operation input type
405 target status
421 play end time
500 screen
502L, 502D, 502U, 502R moving path
504 benchmark line
700 gaming device
701 output unit
702 reception unit
703 determination unit
704 detection unit
705 score unit
710 speaker

What is claimed is:

1. A gaming device (700), comprising:
an output unit (701) starting to output sound of a given tone at a given task time;
a reception unit (702) receiving operation input from the player; and
a determination unit (703) determining whether the time when said operation input is received (“the operation time” hereafter) is included in a given task time span including said task time,
wherein said output unit (701) changes the volume of the sound having started to be output at said task time in accordance with the determination result by said determination unit (703).

2. The gaming device (700) according to claim 1, wherein:
said task time span is from the time precedent to said task time by a given preceding time to the time after elapse of a time period during which said sound is output since said task time.

3. The gaming device (700) according to claim 1, wherein:
said determination unit (703) further determines whether said operation time is after said task time span; and
said output unit (701) changes the volume of the sound having started to be output since said task time to zero if said determination unit (703) determines that said operation time is after said task time span.

4. The gaming device (700) according to claim 1, wherein:
operation input received by said reception unit (702) is operation input associated with said given task time or other operation input;
said determination unit (703) determines whether the time when said other operation input is received is included in said task time span; and
said output unit (701) changes the volume of the sound output since said task time to zero when said determination unit (703) determines that the time if said other operation input is received is included in said task time span.

5. The gaming device (700) according to claim 1, further comprising:
a detection unit (704) detecting the time difference between said operation time and task time,
wherein said output unit (701) changes the volume of the sound output since said task time in accordance with said detected time difference if said determination unit (703) determines that said operation time is included in said task time span.

6. The gaming device (700) according to claim 5, wherein:
said output unit (701) increases the volume of the sound output since said task time as said detected time difference is smaller.

7. The gaming device (700) according to claim 5, further comprising:
a score unit (705) accumulating scores corresponding to said detected time difference.

8. A game control method executed by a gaming device (700) comprising an output unit (701), a reception unit (702), and a determination unit (703), the method comprising:
an output step that said output unit (701) performs outputting sound of a given tone at a given task time;
a reception step that said reception unit (702) performs receiving operation input from a player; and
a determination step that said determination unit (703) performs determining whether the time when said operation input is received (“the operation time” hereafter) is included in a given task time span including said task time,
and in said output step, said output unit (701) performs changing the volume of the sound having started to be output at said task time in accordance with the determination result by said determination unit (703).

9. A computer-readable information recording medium recording a program that allows a computer to function as:
an output unit (701) starting to output sound of a given tone at a given task time;
a reception unit (702) receiving operation input from the player; and
a determination unit (703) determining whether the time when said operation input is received (“the operation time” hereafter) is included in a given task time span including said task time,
wherein said output unit (701) changes the volume of the sound having started to be output at said task time in accordance with the determination result by said determination unit (703).

10. A program that allows a computer to function as:
an output unit (701) starting to output sound of a given tone at a given task time;
a reception unit (702) receiving operation input from the player; and
a determination unit (703) determining whether the time when said operation input is received (“the operation time” hereafter) is included in a given task time span including said task time,
wherein said output unit (701) changes the volume of the sound having started to be output at said task time in accordance with the determination result by said determination unit (703).
